(19) United States
(12) Patent Application Publication
(10) Pub. No.: US 2023/0306205 A1
(43) Pub. Date: Sep. 28, 2023

(54) SYSTEM AND METHOD FOR PERSONALIZED CONVERSATIONAL AGENTS TRAVELLING THROUGH SPACE AND TIME

(71) Applicant: Urbanoid Inc., Montréal (CA)

(72) Inventors: Pascal MAEDER, Montréal (CA); Hafsa ENNAJARI, Montréal (CA); Leonid REINOSO MEDINA, Montréal (CA)

(21) Appl. No.: 18/146,125

(22) Filed: Dec. 23, 2022

Related U.S. Application Data
(60) Provisional application No. 63/324,310, filed on Mar. 28, 2022.

(51) Int. Cl. G06F 40/35; G06F 16/33

(52) U.S. Cl. CPC G06F 40/35; G06F 16/3344; G06F 16/3334

(57) ABSTRACT

A method and system is provided for creating and implementing personalized conversational agents representing historical figures travelling through space and time. These agents can process and analyse natural language utterances expressed by a user and generate knowledgeable and contextualized responses when prompted. The proposed agents can reply to existing conversations, initiate meaningful conversation topics to engage other users. The personalized conversational agents have the ability to navigate freely in space and time, while conditioning their conversational responses on their current space and time coordinates. Natural language processing (NLP) models are used to derive a conversation topic, its related space and time information based on the existing information available about the historical figure of interest. A dialogue model is then trained on popular datasets along with the retrieved knowledge and persona information about the historical characters to allow the agents to conduct meaningful and engaging conversations with multiple users.

### CROSS-REFERENCE TO RELATED APPLICATIONS

The present application claims priority to U.S. Provisional Patent Application Ser. No. 63/324,310 filed on Mar. 28, 2022, the content of which is incorporated herein by reference in its entirety.

### FIELD

The present technology relates to machine learning (ML) and natural language processing (NLP) in general, and more specifically to a method of and a system for training and deploying personalized conversational agents in a space-time service platform.

### BACKGROUND

Autonomy

Conversational agents have come a long way since the first MIT experiment Eliza. The way the conversational agents carry conversation is ever more natural and the list of tasks they can perform is always growing longer. Improvements in artificial intelligence have given conversational agents greater autonomy. In October 2020, Facebook published a paper on the Web-Enabled Simulation (WES) project. In this experiment, all users of a simulated web community are represented by agents, each simulating user behaviour to try out new features. The community was scaled down but proportionate with Facebook's real number of users. This experiment and the new Web-Enabled Simulation system area of study demonstrates the autonomy of modern conversational agents, in that they are literally imitating real users in new features testing.

Personalization

Not only have conversational agents increased in autonomy, but an area of study specializes in increasing artificial intelligence-based systems abilities to enable personalized conversational agents. One could argue that the personalization of conversational agents is part of their improved autonomy. The level of personalization that is possible nowadays is rising so high that it is reaching out of the personalized conversational agents towards embodied conversational agents. U.S. Pat. No. 10,853,717 entitled “Creating A Conversational Chatbot Of A Specific Person” (hereinafter “the '717 Patent”) and assigned to Microsoft Technology Licensing LLC, discloses working on chatbots that would integrate a broad range of technologies, such as but not limited to facial and speech recognition as well as 3D modelling to enable the agents to embody a person, alive or deceased.

Indeed, the ever-increasing autonomy and possibilities of personalization in chatbots is setting the plate for inventions rooted in historical interactions, but they have yet to be integrated on a spatiotemporal platform.

This gap exists in a situation wherein there is a continued expansion of extended reality platforms.

There is a need for personalized conversational agents that could be integrated on space-time platforms, notably in an open and intelligent game context and in space-time messaging systems.

### SUMMARY

It is an object of one or more embodiments of the present technology to ameliorate at least some of the inconveniences present in the prior art. One or more embodiments of the present technology may provide and/or broaden the scope of approaches to and/or methods of achieving the aims and objects of the present technology.

Developers of the present technology have appreciated that there is a need for a method and a system to enable personalized conversational agents to virtually navigate through space-time. The present technology is intrinsic with the mentioned platforms as space-time mobility can only be designed in personalized conversational agents if they can extract space coordinates and timeframe coordinates from both the platform they are integrated on, and the data they are trained with. Applications of one or more embodiments of the present technology are therefore as numerous as space-time platforms can be.

One or more embodiments of the present technology can firstly find use in the gaming world industry. Since the beginning of the 2000s, we have seen a rise in demand for games that operate on open and intelligent systems, such as Second Life, a massively multiplayer online role-playing game (MMORPG) consisting of 3D based user-generated content. Such games do not necessarily have objectives (for example, quests) and the narrative is not rooted in manufactured conflictual dynamics between the users; the approach aims to create a metaverse (i.e., a collective virtual shared space) where users evolve and interact. When the fundamental purpose of the game is to interact with a metaverse, it is easy to see how personalized conversational agents capable of space-time virtual mobility would make the game more interesting and dynamic for users. Moreover, the present technology is likely to serve other types of online games, single or multiplayer, as it brings more momentum to space-time narrative and platform in a gaming world where the line between the reality and the game worlds is always getting thinner.

One or more embodiments of the present technology can also find a use in space-time messaging systems. Space-time messaging systems are now being introduced; the Canadian company Urbanoid Inc. presented in 2020, in collaboration with Concordia University, the space-time messaging system x-ode, wherein an integration of spacetime mobile personalized conversational agents will bring a more comprehensive use of the spatio-temporal dimension. Space-time messaging systems can be used for personal interest, self-fulfilment and educational purposes.

The present technology is part of a bigger movement towards the digitalization of the Big Data of the past. Projects such as the Venice Time Machine, launched by École Polytechnique Fédérale de Lausanne and the Ca' Foscari University of Venice, use multiple technologies such as, but not limited to, index-driven digitization, cadastral computing, visual pattern discovery and automatic reference extraction to map out Venice's economical, social, cultural and geographical evolution across time. It aims to provide different actors such as industry, policy and civil society with the most comprehensive evolutive portrait of the specific location. This project, also supported by scholars from Princeton and Columbia universities, will strongly impact key sectors such as urban planning, land management and smart cities development. Similar projects are bound to multiply as they have received a critical acclaim that led to form an even bigger initiative in the European Time Machine project. Personalized conversational agents with space and time mobility in the context of the present technology align with the Venice Time Machine mandate to provide a comprehensive intelligent space-time platform to inform about the past and help raising the tourism profile of the city.

Finally, with the emergence of the concept of virtual environments powered by augmented reality (AR) and virtual reality (VR), one or more embodiments of the present technology can have a potential use in simulating a virtual metaverse. Many technology companies such as Meta™ Microsoft™ and Google™ have started to build platforms with devices for a full metaverse experience, where typical applications include buying virtual lands, meeting with friends, organizing meetings, concerts and trips. The integration of the present personalized conversational agents that can navigate in space and time can offer people a unique experience, where they can interact with historical or fictional characters in an immersive digital environment.

Thus, one or more embodiments of the present technology are directed to a method of and system for training and using personalized conversational agents in a space-time service platform as well as in universal mixed reality applications aimed at connecting virtual agents to real world environments to promote education and urban tourism. In this context, the personalized conversational agents can guide users in their trips and journeys. This means that this system will act as a personal virtual touristic assistance, offering an interactive and engaging solution for those who are eager to explore the city by themselves, meet the involved historical figures, and know all the history behind. The reason behind choosing to integrate historical figures in this use case, is that they are the most appropriate persons to discuss and lighten users about Points Of Interests (POIs) they have built, discovered or interacted with. It is to note that, there are many other use cases where the present technology may be directly integrated, such as video games, metaverses, social media, and the like.

In accordance with a broad aspect of the present technology, there is provided a method for providing a relevant natural language response to a conversation thread by a trained conversational agent model, the method being executed by a processor. The method comprises: obtaining a conversation thread comprises at least one message, the conversation thread being associated with space-time coordinates, obtaining, based at least on the space-time coordinates, a character identity for the trained conversational agent model, obtaining, based on the character identity, a supportive knowledge text associated with the character, encoding the conversation thread and the supportive knowledge text to obtain an encoded conversation thread and encoded knowledge text portions, selecting, based on the encoded conversation thread, an encoded knowledge text portion, and generating, by the trained conversational agent model, based at least on the encoded knowledge text portion, a relevant natural language response to the conversation thread.

In one or more implementations of the method, the conversational agent model is based a transformer language model (TLM).

In one or more implementations of the method, the response is related to an event in a life of the character, the event being associated with at least a portion of the space-time coordinates.

In one or more implementations of the method, the response comprises one of: an informative text message and an interrogative text message.

In one or more implementations of the method, said generating of, by the trained conversational agent model, based at least on the encoded knowledge text portion, the relevant natural language response to the conversation thread is further based on encoded persona information, the encoded persona information having been generated by encoding persona sentences indicative of at least one of: persona facts about the character and a writing style of the character.

In one or more implementations of the method, the method further comprises, during a training procedure of the conversational agent model: obtaining a past conversation thread associated with space-time coordinates, the past conversation thread comprises a plurality of messages, obtaining a supportive knowledge text associated with a character, generating, based on the past conversation thread, a search query, embedding each of the search query and the supportive knowledge text to obtain a search query vector and supportive knowledge text vectors, determining a respective distance between the search query vector and each supportive knowledge text vector, selecting, based on the respective distances, a first set of knowledge sentences from the supportive knowledge text, extracting a set of keywords from the conversation thread, matching the set of keywords with a set of knowledge sentences from the supportive knowledge text, selecting, based on said matching, a second set of knowledge sentences from the supportive knowledge text, and training the conversational agent model to generate a response to a given conversation thread based on: the first set of knowledge sentences and the second set of knowledge sentences.

In one or more implementations of the method, the supportive knowledge text comprises supportive events knowledge text comprising a set of events each associated with space-time coordinates.

In one or more implementations of the method, said training of the conversational agent model to generate the response to the given conversation thread based on the first set of knowledge sentences and the second set of knowledge sentences is further based on a candidate answer, the candidate answer having been generated by: determining, based on the search query, a question, and predicting, using a knowledge-based question-answering model, a candidate answer to the question, said predicting being based on the supportive knowledge text.

In one or more implementations of the method, the character comprises a historical character.

In one or more implementations of the method, the conversation thread is associated with a point of interest (POI) associated with the space-time coordinates, and the selected encoded knowledge text portion is related to the POI.

In one or more implementations of the method, the method further comprises, prior to said obtaining of the supportive knowledge text associated with the character: obtaining, from a knowledge source database, at least one text document associated with the character, parsing the at least one text document to obtain a respective parsed tree for each sentence, extracting a set of events from the at least one text document, each event being associated with space-time coordinates, said extracting comprises, for each respective parsed document: extracting, using a first name entity recognition model, respective temporal information, extracting, using a second name entity recognition model, respective location information, and extracting a respective event of the set of events, the respective event being associated with the respective temporal information and the respective location information, and storing the set of events as the supportive knowledge text.

In accordance with a broad aspect of the present technology, there is provided a system for providing a relevant natural language response to a conversation thread by a trained conversational agent model. The system comprises: a non-transitory storage medium storing computer-readable instructions, and a processor operatively connected to the non-transitory storage medium. The processor, upon executing the computer-readable instructions, being configured for: obtaining a conversation thread comprises at least one message, the conversation thread being associated with space-time coordinates, obtaining, based at least on the space-time coordinates, a character identity for the trained conversational agent model, obtaining, based on the character identity, a supportive knowledge text associated with the character, encoding the conversation thread and the supportive knowledge text to obtain an encoded conversation thread and encoded knowledge text portions, selecting, based on the encoded conversation thread, an encoded knowledge text portion, and generating, by the trained conversational agent model, based at least on the encoded knowledge text portion, a relevant natural language response to the conversation thread.

In one or more implementations of the system, the conversational agent model is based a transformer language model (TLM).

In one or more implementations of the system, the response is related to an event in a life of the character, the event being associated with at least a portion of the space-time coordinates.

In one or more implementations of the system, the response comprises one of: an informative text message and an interrogative text message.

In one or more implementations of the system, said generating of, by the trained conversational agent model, based at least on the encoded knowledge text portion, the relevant natural language response to the conversation thread is further based on encoded persona information, the encoded persona information having been generated by encoding persona sentences indicative of at least one of: persona facts about the character and a writing style of the character.

In one or more implementations of the system, said processor is further configured for, during a training procedure of the conversational agent model: obtaining a past conversation thread associated with space-time coordinates, the past conversation thread comprises a plurality of messages, obtaining a supportive knowledge text associated with a character, generating, based on the past conversation thread, a search query, embedding each of the search query and the supportive knowledge text to obtain a search query vector and supportive knowledge text vectors, determining a respective distance between the search query vector and each supportive knowledge text vector, selecting, based on the respective distances, a first set of knowledge sentences from the supportive knowledge text, extracting a set of keywords from the conversation thread, matching the set of keywords with a set of knowledge sentences from the supportive knowledge text, selecting, based on said matching, a second set of knowledge sentences from the supportive knowledge text, and training the conversational agent model to generate a response to a given conversation thread based on: the first set of knowledge sentences and the second set of knowledge sentences.

In one or more implementations of the system, the supportive knowledge text comprises supportive events knowledge text comprising a set of events each associated with space-time coordinates.

In one or more implementations of the system, said training of the conversational agent model to generate the response to the given conversation thread based on the first set of knowledge sentences and the second set of knowledge sentences is further based on a candidate answer, the candidate answer having been generated by: determining, based on the search query, a question, and predicting, using a knowledge-based question-answering model, a candidate answer to the question, said predicting being based on the supportive knowledge text.

In one or more implementations of the system, the character comprises a historical character.

In one or more implementations of the system, the conversation thread is associated with a point of interest (POI) associated with the space-time coordinates, and the selected encoded knowledge text portion is related to the POI.

In one or more implementations of the system, said processor is further configured for, prior to said obtaining of the supportive knowledge text associated with the character: obtaining, from a knowledge source database, at least one text document associated with the character, parsing the at least one text document to obtain a respective parsed tree for each sentence, extracting a set of events from the at least one text document, each event being associated with space-time coordinates, said extracting comprises, for each respective parsed document: extracting, using a first name entity recognition model, respective temporal information, extracting, using a second name entity recognition model, respective location information, and extracting a respective event of the set of events, the respective event being associated with the respective temporal information and the respective location information, and storing the set of events as the supportive knowledge text.

In accordance with a broad aspect of the present technology, there is provided a method for providing a response to a conversation thread by a conversational agent model having been trained therefor, the method being executed by a processor. The method comprises: obtaining a conversation thread comprising at least one message, the conversation thread being associated with spatio-temporal coordinates, obtaining, based at least in part on the spatio-temporal coordinates, a list of characters, obtaining, for each character of the list of characters, a respective text portion relating to the character, encoding, using a text vectorization model, each of the respective text portions representing a character background summary and the conversation thread to obtain respective encoded text portions and a respective encoded conversation thread, determining a similarity score between each respective encoded text portion and the respective encoded conversation thread, the similarity score being indicative of a level of similarity between the respective background summary text portion and the conversation thread, determining if a given similarity score associated with a given character is above a threshold, and if the given similarity score is above the threshold: generating, using the conversational agent model, based on the respective background summary text portion associated with the respective character, a response message to the conversation thread.

In one or more implementations, the character comprises a historical character.

In one or more implementations, the conversational agent model comprises a transformer language model.

In one or more implementations, the response to the at least one message comprises a question.

In one or more implementations, said generating of, using the conversational agent model, based on the respective background summary text portion associated with the respective character and the at least one message, the response message to the conversation thread comprises: obtaining supportive knowledge text comprises a set of knowledge sentences associated with the character, encoding, via an encoder of the conversational agent model, the at least one message and the set of knowledge sentences to obtain respectively an encoded message and encoded candidate knowledge sentences, selecting, via a knowledge attention mechanism of the conversational agent model, based on the at least one message, a selected encoded knowledge sentence, and decoding, via a decoder of the conversational agent model, the selected encoded knowledge sentence to obtain the response.

In one or more implementations, the method further comprises, prior to said generating of, via the encoder of the conversational agent model, the set of encoded candidate sentences: obtaining, from a knowledge source, at least one text document associated with the character, parsing the at least one text document to obtain a respective parsed tree for each sentence, extracting a set of events from the at least one text document, each event being associated with spatio-temporal coordinates, said extracting comprises, for each respective parsed sentence or sentences in text document: extracting, using a first name entity recognition model, respective temporal information, extracting, using a second name entity recognition model, respective location information, and extracting a respective event of the set of events, the respective event being associated with the respective temporal information and the respective location information, and storing the set of events.

In one or more implementations, the set of events is stored as a supportive events knowledge text in associated with the supportive knowledge text.

In one or more implementations, the conversational agent has been previously trained to imitate a writing style of the given character.

In accordance with a broad aspect of the present technology, there is provided a method for training a conversational agent model to provide responses in a dialogue, the method being executed by a processor. The method comprises: obtaining a dialogue from the set of dialogues, the dialogue being associated with a respective topic and/or respective spatio-temporal coordinates, obtaining, from a knowledge source, for each respective topic in the set of dialogues, a respective set of background knowledge text associated with at least one character, training the conversational agent model on the set of dialogues to thereby generate a trained conversational agent model, the training comprising, for a given dialogue of the set of dialogues: generating, via an encoder of the conversational agent model, for the given dialogue, an encoded dialogue context, generating, via the encoder of the conversational agent model, based on a given one of the respective background knowledge texts, a set of encoded candidate sentences, selecting, using an attention mechanism of the conversational agent model, based on the encoded dialogue context and the respective spatio-temporal coordinates, a given candidate sentence from the set of encoded candidate sentences, generating, by a decoder of the conversational agent model, based on the given candidate sentence, a dialogue response in the given dialogue, and providing the trained conversational agent model.

In one or more implementations, the conversational agent model is a generative model.

In one or more implementations, the generative model is a transformer language model.

In one or more implementations, the training comprises minimizing a negative log-likelihood of the dialogue response.

In one or more implementations, the character comprises a historical character.

In one or more implementations, the dialogue comprises at least one utterance.

In one or more implementations, the method further comprises, prior to said generating of, via the encoder of the conversational agent model, the set of encoded candidate sentences: obtaining, from a knowledge source, at least one text document associated with the character, parsing the at least one text document to obtain a respective parsed tree for each sentence, extracting a set of events from the at least one text document, each event being associated with spatio-temporal coordinates, said extracting comprises, for each respective parsed document: extracting, using a first name entity recognition model, respective temporal information, extracting, using a second name entity recognition model, respective location information, and extracting a respective event of the set of events, the respective event being associated with the respective temporal information and the respective location information, and storing the set of events.

In one or more implementations, the set of events is stored as a supportive events knowledge text in associated with the supportive knowledge text.

In one or more implementations, the extracting the respective event of the set of events comprises using a rule-based model.

In one or more implementations, each event is associated with a title and a content.

In one or more implementations, the first name entity recognition model comprises a Bidirectional Encoder Representations from Transformer (BERT) model having been trained to recognize location entities.

In one or more implementations, the second name entity recognition model comprises a Bidirectional Encoder Representations from Transformer (BERT) model having been trained to recognize temporal information.

In one or more implementations, the location information comprises location coordinates and a relative zoom level.

### Terms and Definitions

In the context of the present specification, a “server” is a computer program that is running on appropriate hardware and is capable of receiving and processing requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

In the context of the present specification, “electronic device” is any computing apparatus or computer hardware that is capable of running software appropriate to the relevant task at hand. Thus, some (non-limiting) examples of electronic devices include general purpose personal computers (desktops, laptops, netbooks, etc.), mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client electronic devices, associated with a user, such as personal computers, tablets, smartphones, VR/AR headsets and the like.

In the context of the present specification, the expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document may include the document itself (i.e., its contents), or it may be a unique document descriptor identifying a file with respect to a particular file system, or some other means of directing the recipient of the indication to a network location, memory address, database table, or other location where the file may be accessed. As one skilled in the art will appreciate, the degree of precision required in such an indication depends on the extent of any prior understanding about the interpretation to be given to information being exchanged as between the sender and the recipient of the indication. For example, if it will be appreciated that prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it will be appreciated that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It will be appreciated that some aspects of the present technology that have resulted from attempting to attain the above-mentioned object may not satisfy this object and/or may satisfy other objects not specifically recited herein.

Additional and/or alternative features, aspects and advantages of implementations of one or more embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of an electronic device in accordance with one or more non-limiting embodiments of the present technology.

FIG. 2 depicts a schematic diagram of a communication system in accordance with one or more non-limiting embodiments of the present technology.

FIG. 3 depicts a schematic diagram of a graphical user interface of a space-time service (STS) platform in accordance with one or more non-limiting embodiments of the present technology.

FIG. 4 depicts a schematic diagram of an identity extraction procedure in accordance with one or more non-limiting embodiments of the present technology.

FIG. 5A and FIG. 5B depict a schematic diagram of a historical data extraction procedure and a conversion procedure in accordance with one or more non-limiting embodiments of the present technology.

FIG. 6 depicts a schematic diagram of a knowledge retrieval procedure in accordance with one or more non-limiting embodiments of the present technology.

FIG. 7 depicts a schematic diagram of a character relevance determination procedure in accordance with one or more non-limiting embodiments of the present technology.

FIG. 8 depicts a schematic diagram of a post triggering procedure be described in accordance with one or more non-limiting embodiments of the present technology.

FIG. 9A and FIG. 9B depict respectively a schematic diagram of a post of interest evaluation mechanism and a post evaluation procedure in accordance with one or more non-limiting embodiments of the present technology.

FIG. 10 depicts a schematic diagram of point of interest (POI) and historical figure extraction procedure in accordance with one or more non-limiting embodiments of the present technology.

FIG. 11 depicts a schematic diagram of a knowledge graph that may be used by the POI and historical figure extraction procedure of FIG. 10.

FIG. 12 depicts a schematic diagram of a dialogue participation procedure executed by a conversational agent in accordance with one or more non-limiting embodiments of the present technology.

FIG. 13 depicts a schematic diagram of a dialogue participation procedure with persona information executed by a conversational agent in accordance with one or more non-limiting embodiments of the present technology.

FIG. 14 depicts a flow chart of a method for extracting historical events associated with historical characters from a knowledge source in accordance with one or more non-limiting embodiments of the present technology.

FIG. 15 depicts a flow chart of a method for selecting and evaluating posts of interests on the space-time service (STS) platform in accordance with one or more non-limiting embodiments of the present technology.

FIG. 16 depicts a flow chart of a method generating a message on the STS platform by using a conversational agent in accordance with one or more non-limiting embodiments of the present technology.

FIG. 17 depicts an example of a dependency tree having been generated during the historical data extraction procedure of FIG. 5A.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology.

Furthermore, as an aid to understanding, the following description may describe relatively simplified implementations of the present technology. As a person skilled in the art will appreciate, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by the skilled addressee that any block diagram herein represents conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, “processing device” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some non-limiting embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

Electronic Device

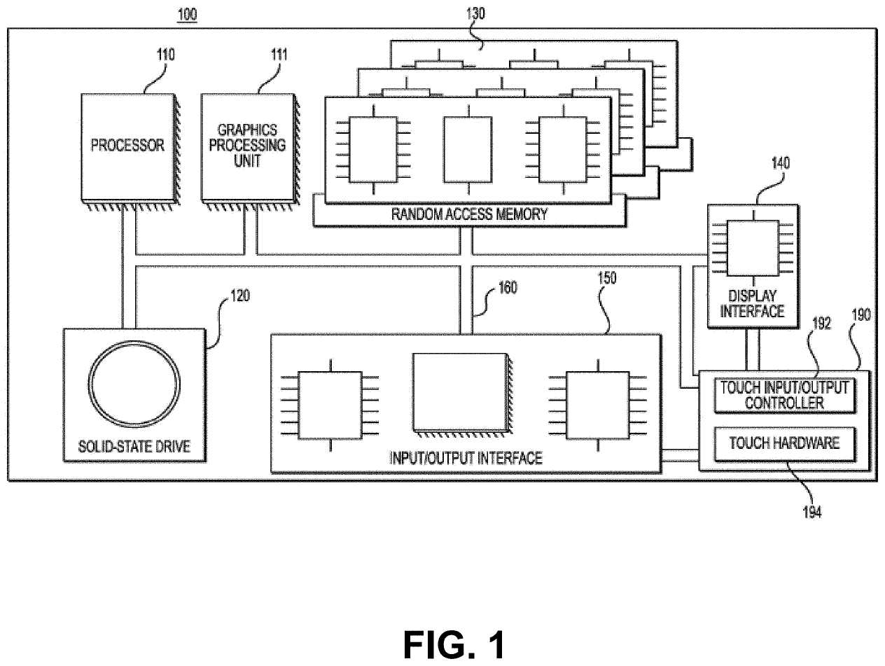

Now referring to FIG. 1, there is shown an electronic device 100 suitable for use with one or more implementations of the present technology, the electronic device 100 comprises various hardware components including one or more single or multi-core processors collectively represented by processor 110, a graphics processing unit (GPU) 111, a solid-state drive 120, a random access memory 130, a display interface 140, and an input/output interface 150.

Communication between the various components of the electronic device 100 may be enabled by one or more internal and/or external buses 160 (e.g., a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In one or more embodiments, the touchscreen 190 is the display. The touchscreen 190 may equally be referred to as a screen 190. In the embodiment illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In one or more embodiments, the input/output interface 150 may be connected to a keyboard (not shown), a mouse (not shown) or a trackpad (not shown) enabling the user to interact with the electronic device 100 in addition or in replacement of the touchscreen 190.

According to one or more implementations of the present technology, the solid-state drive 120 stores program instructions suitable for being loaded into the random-access memory 130 and executed by the processor 110 and/or the GPU 111 for inter alia extracting historical data and providing conversational agent on a space-time message platform based on the extracted historical data. For example, the program instructions may be part of a library or an application.

It will be appreciated that the electronic device 100 may be implemented as a server, a desktop computer, a laptop computer, a tablet, a smartphone, a personal digital assistant or any device that may be configured to implement the present technology, as it may be appreciated by a person skilled in the art.

System

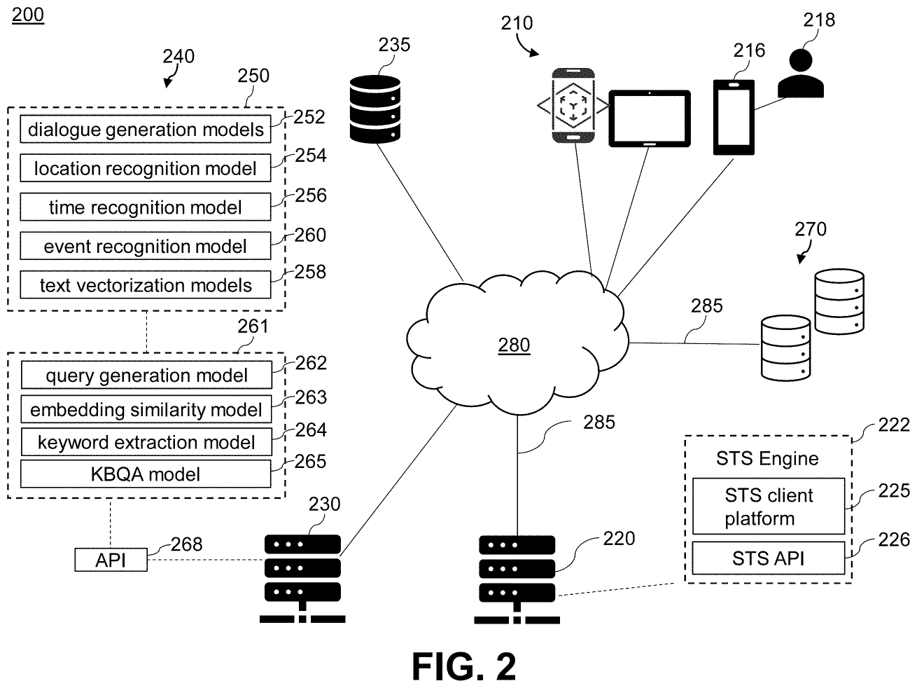

Referring to FIG. 2, there is shown a schematic diagram of a communication system 200, the communication system 200 being suitable for implementing one or more non-limiting embodiments of the present technology. It is to be expressly understood that the communication system 200 as shown is merely an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the communication system 200 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 200 may provide in certain instances simple implementations of the present technology, and that where such is the case they have been presented in this manner as an aid to understanding. As persons skilled in the art would understand, various implementations of the present technology may be of a greater complexity.

The communication system 200 comprises inter alia a plurality of client devices 210, a space-time service (STS) server 220, a conversational agent engine comprising a set of machine learning (ML) models 240, a training server 230, a database 235 and a knowledge database 270 communicatively coupled over a communications network 280.

Client Device

The system 200 comprises a plurality of client devices 210.

A given client device 216 of the plurality of client devices 210 is associated with a respective user 218 (only one depicted in FIG. 2). As such, the client device 216 can sometimes be referred to as an “electronic device”, “end user device” or “client electronic device”. It should be noted that the fact that the client device 216 is associated with the user 218 does not need to suggest or imply any mode of operation—such as a need to log in, a need to be registered, or the like.

Each given client device 216 comprises one or more components of the electronic device 100 such as one or more single or multi-core processors collectively represented by processor 110, the graphics processing unit (GPU) 111, the solid-state drive 120, the random-access memory 130, the display interface 140, and the input/output interface 150.

It will be appreciated that the given client device 216 may be implemented as a server, a desktop computer, a laptop, a smartphone, and the like.

While only one three client devices 210 are illustrated in FIG. 2, it will be appreciated that there may be dozens, hundreds, or thousands of client devices without departing from the scope of the present technology.

In one or more embodiments, the given client device 216 is configured to execute a browser application (not illustrated). The purpose of the given browser application is to enable the user 218 to access one or more web resources. How the given browser application is implemented is not particularly limited. Non-limiting examples of the given browser application that is executable by the client device 216 include Google™ Chrome™, Mozilla™ Firefox™, Microsoft™ Edge™, and Apple™ Safari™.

In one or more embodiments, the user 218 uses the browser application to access the space-time service (STS) client platform 225 provided by the STS server 220. In one or more other embodiments, the STS client platform 225 may be part of a stand-alone software application executed by the respective client device.

Space-Time Service (STS) Engine

The STS server 220 executes an STS engine 222.

The STS engine 222 is configured to inter alia: (i) execute a space-time service (STS) service 224 and STS client platform 225; (ii) provide the STS platform 225 to client devices 210 such as the client device 216; and (iii) manage and store information relating to the STS engine 222, such as user interactions, message threads and the like, through the STS service 224 and the STS API interface 226.

How the STS server 220 is configured to do so will be explained in more detail herein below.

It will be appreciated that the STS server 220 can be implemented as a conventional computer server and may comprise at least some of the features of the electronic device 100 shown in FIG. 1. In a non-limiting example of one or more embodiments of the present technology, the STS server 220 is implemented as a server running an operating system (OS). Needless to say that the STS server 220 may be implemented in any suitable hardware and/or software and/or firmware or a combination thereof. In the disclosed non-limiting embodiment of present technology, the STS server 220 is a single server. In one or more alternative non-limiting embodiments of the present technology, the functionality of the STS server 220 may be distributed and may be implemented via multiple servers (not shown).

The implementation of the STS server 220 is well known to the person skilled in the art. However, the STS server 220 comprises a communication interface configured to communicate with various entities (such as the database 235, for example and other devices potentially coupled to the communication network 280) via the communication network 280. The STS server 220 further comprises at least one computer processor (e.g., the processor 110 of the electronic device 100) operationally connected with the communication interface and structured and configured to execute various processes to be described herein.

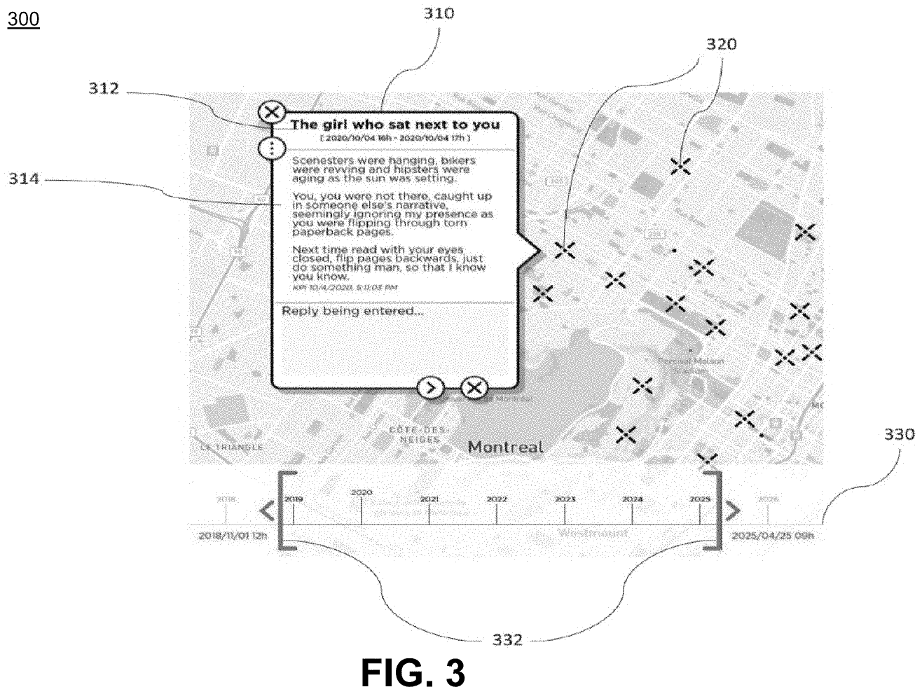

With brief reference to FIG. 3, a non-limiting example of a graphical user interface (GUI) of the STS client platform 225 accessible to the given client device 216 is illustrated in accordance with one or more non-limiting embodiments of the present technology.

The STS client platform 225 enables users to post and view messages on a graphical representation of a location on a map, which may be viewed at different moments in time by selecting a specific date and time range. The STS engine 222 may be accessed via the plurality of client devices 216, for example via a browser application or a stand-alone software application.

The STS client platform 225 enables selecting a set of coordinates using a graphical representation of a geographical location, in which the set of coordinates includes a geographical location, the area or dimension information, and a time or a time span. The STS client platform 225 enables attaching a post or message to the set of coordinates, the post containing text and optionally hyperlinks, image files, audio files or video files. In one or more alternative embodiments, the STS client platform 225 may be a component of another platform or service, such as a social media service, a metaverse, a mixed reality platform, a video game, etc. In this context, the STS client platform 225 enables users to interact in space and time with each other via avatars or other types of representations.

As shown in FIG. 3, the STS client platform 225 enables searching and retrieving posts, which visibility can be filtered by navigating a graphical representation of a geographical location in longitude, latitude and scale and by selecting a time, a time frame, a time interval or a duration, using a time-sequencing graphical representation. Filtering is achieved by using a magnification tool 300 for zoom-in over said graphical representation. Time selection is achieved by moving a scale 332 (a glider) to the representation of a specific time and optionally its duration, expressed as a span between a start date and an end date. The posts 320 including replies are organized in the form of conversation threads. For example, the post 310 represents a thread that is initiated using a post title 312 and a post content 314.

The STS engine 222 enables augmenting said posts by further contributions from any user, in the form of answers to a post, or contribution to a thread of messages. Users can participate by viewing, creating of replying to posts. Anonymous users can enter in relation with unlimited amount of other anonymous users through relational posts.

The STS engine 222 may provide an application programming interface (API) 226 for accessing conversation threads comprising messages on the STS engine 222. In one or more embodiments, information related to the STS engine 222 may be transmitted and stored in the database 235. Such information includes for examples active conversation threads, posts, metadata about posts and users, statistics, and the like.

Turning back to FIG. 2, the system 200 comprises inter alia the training server 230.

Training Server

The training server 230 is configured to inter alia: (i) access a set of machine learning (ML) models 240; (ii) obtain one or more training datasets from the database 235; (iii) train the set of ML models 240; (iv) connect to the knowledge database 270 to obtain information therefrom; (v) extract and recognize, using one or more of the set of ML models 240, entities associated with events, locations and temporal information from the historical information; (vi) provide the set of ML models 240 including conversational agents on the STS engine 222 for interaction with users based on the extracted historical information.

How the training server 230 is configured to do so and additional functionalities will be explained in more detail herein below.

In one or more alternative embodiments, the STS engine 220 and the training server 230 may be implemented as a single server.

It will be appreciated that the training server 230 can be implemented as a conventional computer server and may comprise at least some of the features of the electronic device 100 shown in FIG. 1. In a non-limiting example of one or more embodiments of the present technology, the training server 230 is implemented as a server running an operating system (OS). Needless to say that the training server 230 may be implemented in any suitable hardware and/or software and/or firmware or a combination thereof. In the disclosed non-limiting embodiment of present technology, the training server 230 is a single server. In one or more alternative non-limiting embodiments of the present technology, the functionality of the training server 230 may be distributed and may be implemented via multiple servers (not shown).

The implementation of the training server 230 is well known to the person skilled in the art. However, the training server 230 comprises a communication interface (not shown) configured to communicate with various entities (such as the database 235, for example and other devices potentially coupled to the communication network 280) via the communication network 280. The training server 230 further comprises at least one computer processor (e.g., the processor 110 or GPU 111 of the electronic device 100) operationally connected with the communication interface and structured and configured to execute various processes to be described herein.

Machine Learning Models

The training server 230 has access to a set of machine learning (ML) models 240, which comprise or implement a conversational agents engine 240 and knowledge retrieval models 261.

In one or more embodiments, the training server 230 also executes an API 268 which enables other devices in the communication system 200 to interact with the set of ML models 240. In one or more alternative embodiments, the training server 230 may execute a portion of the ML models 240 and access another portion of ML models 240 on one or more other servers implementing an API (not illustrated).

Conversational Agents Engine

The conversational agent engine 250 comprises inter alia dialogue generation models 252, a location recognition model 254, a time recognition model 256, an event recognition model 260, a text vectorization model 258, a query generation model 262, a keyword extraction model 264, and a knowledge-based question-answering (KBQA) model 265.

Dialogue Generation Models

Each dialogue generation model 252, also referred to as conversational agent or conversational agent models, is configured to inter alia: (i) take the identity of (i.e., impersonate) a character, such as a historical character; (ii) receive input character text related to the character, the input text relating to personality traits and/or events in the life of the character and being associated with space-time coordinates; (iii) receive a dialogue context (i.e., a conversation thread comprising one or more messages) associated with space-time coordinates; and (iv) generate, based on the character input text and the dialogue context, natural language utterances which may be informative or interrogative utterances.

The dialogue generation model 252 is used to implement conversational agents taking the identity of characters which may create conversations and/or reply to conversations by providing natural language utterances (e.g., sentences) on a platform, such as the STS engine 222. The provided utterances may be in the form of informative speech statements or interrogative speech statements (e.g., in the form of questions) based on factual information related to a location, time, event, an ongoing conversation, the character's biographical details and other characters interest to users of a platform such as the STS engine 222.

Each dialogue generation model 252 is a deep neural network (DNN)-based model. In one or more embodiments, the dialogue generation model 252 is transformer-based generative model with memory networks, e.g., an encoder-decoder model architecture with attention mechanism.

The dialogue generation model 252 in the form of transformer is a DNN having a sequence-to-sequence architecture, which transforms a given sequence of elements, such as a sequence of words in a sentence, into another sequence of words.

As a non-limiting example, the dialogue generation model 252 may comprise a single GPT-like transformer based on the OpenAI GPT model.

In one or more embodiments, the dialogue generation model 252 includes an encoder and a decoder (not illustrated in FIG. 2). It will be appreciated that the encoder may include one or multiple encoders, and that the decoder may include one or multiple decoders.

The encoder of the dialogue generation model 252 receives as input a first text portion, the first text portion comprising one or more words or sentences.

The encoder of the dialogue generation model 252 takes the input sequence and maps it into a higher dimensional space to obtain an n-dimensional vector, which is fed into the decoder which turns it into an output sequence comprising one or more words. The dialogue generation model 252 uses an attention-mechanism that looks at an input sequence and decides at each step which other parts of the sequence are important. For each input that the encoder reads, the attention-mechanism takes into account several other inputs at the same time and decides which ones are important by attributing different weights to those inputs. The encoder will then take as input the encoded sentence and the weights provided by the attention-mechanism.

The encoder comprises a stack of identical layers, where each layer has two sub-layers. The first is a multi-head self-attention mechanism, and the second is a position wise fully connected feed-forward network. Residual connection is employed around each of the two sub-layers, followed by layer normalization. The output of each sub-layer is LayerNorm(x+Sublayer(x)), where Sublayer(x) is the function implemented by the sub-layer itself. As a non-limiting example, the encoder may comprise a stack of layers.

The decoder of the dialogue generation model 252 comprises a stack of identical layers. In addition to the two sub-layers in each layer of the encoder, the decoder inserts a third sub-layer, which performs multi-head attention over the output of the encoder stack. In one or more embodiments, similarly to the encoder, residual connections around each of the sub-layers are employed, followed by layer normalization. The self-attention sub-layer in the decoder stack is modified to prevent positions from attending to subsequent positions. This masking, combined with fact that the output embeddings are offset by one position, ensures that the predictions for position i can depend only on the known outputs at positions less than i. It will be appreciated that there may be alternatives to the type of masking and how the mask is created, however it should be noted that the mechanism of adding masks to diminish or null the attention weights on the masked portions of a sequence could only be removed if the input is expanded quadratically (an input on N words (X row and N columns) would need an NAX input sequence with N rows and N columns) and the input sequence is padded to simulate left-to-right decoding. In one or more alternative embodiments, the attentions may be found via convolution kernels.

In one or more embodiments, layer normalization is moved to the input of each sub-block, and an additional layer normalization is added after the final self-attention block. Additionally, a modified initialization accounting for the accumulation on the residual path with model depth is used.

An attention function maps a query and a set of key-value pairs to an output, where the query, keys, values, and output are all vectors. The output is computed as a weighted sum of the values, where the weight assigned to each value is computed by a compatibility function of the query with the corresponding key.

In one or more embodiments, the dialogue generation backbone model 252 may be a pretrained network.

In one or more embodiments, the dialogue generation model 252 may be trained to minimize a negative log-likelihood of the dialogue response.

In one or more embodiments, the dialogue generation model 252 comprises an encoder, a decoder, a knowledge attention mechanism, and a persona attention mechanism.

How the dialogue generation model 252 is trained and used to provide natural language responses will be explained below in more detail.

In one or more embodiments, the character may be a historical character related to a location and/or time (i.e., space-time coordinates). It is contemplated that the dialogue generation model 252 may be used to provide natural language utterances as a character in other contexts, such as an imaginary character in a virtual reality or video-gaming platform, or to imitate speech of real persons.

Location Recognition Model

The location recognition model 254 is a machine learning model having been trained to perform named entity recognition (NER) from text portions. The location recognition model 254 is a transformer-based model.

In one or more embodiments, the location recognition model 254 is implemented as a Bidirectional Encoder Representations from Transformers (BERT) model.

As a non-limiting example, the location recognition model 254 may be implemented as BERT-base-NER, which is a fine-tuned BERT model for Named Entity Recognition (NER) tasks and which has been trained to recognize four types of entities: location (LOC), organizations (ORG), person (PER) and Miscellaneous (MISC).

The location recognition model 254 is configured to inter alia: (i) receive text; (ii) detect location or spatial information in the text; and (iii) output the detected location or spatial information.

The location recognition model 254 may be trained to recognize locations, as well as synonyms of the locations, past names given to the locations, nicknames given to locations, and any other words relating to the locations.

As a non-limiting example, the text may include one or more sentences, paragraphs and/or document pages.

Time Recognition Model

The time recognition model 256 is also a transformer-based model. In one or more embodiments, the time recognition model 256 is implemented as a Bidirectional Encoder Representations from transformers (BERT) model.

In one or more embodiments, the time recognition model 256 may be trained on the Ontonote-5.0 dataset.

The time recognition model 256 is configured to inter alia: (i) receive a text; (ii) detect temporal information in the text; and (iii) output the temporal information, i.e., recognized time and/or date.

Event Recognition Model

The event recognition model 260 is a machine learning model. In one or more embodiments, the event recognition model 260 is implemented to extract and recognize notable events that marked the life of each character.

In one or more embodiments, the event recognition model 260 is implemented using a rule-based dependency tree parsing model to locate and extract events entities.

The event recognition model 260 is configured to configured to inter alia: (i) receive a text; (ii) detect event information in the text; (iii) cluster similar events; and (iv) output the event information, i.e., recognized character events.

Text Vectorization Model

The text vectorization model 258 is configured to inter alia: (i) receive a text portion including one or more words, sentences, and paragraphs; and (ii) generate an encoded feature vector based on the text portion.

In one or more embodiments, the text feature vector comprises semantic representation of the text portion in an n-dimensional feature space.

In the context of the present technology, the purpose of the text vectorization model 258 is to generate a vector or embedding of text portions such that they can be compared, and their similarity assessed.

In one or more embodiments, the text vectorization model 258 is used to generate text vectors of one or more messages posted by users of the STS engine 222 and textual background knowledge associated with historical characters such that they may be compared, and their similarity or dissimilarity may be quantified.

The text vectorization model 258 has been previously trained to generate vector representations based on text portions.

In one or more alternative embodiments, the text vectorization model 258 may use techniques such as bag-of-words, tokenization, stop words removal, stemming, lemmatization, morphological segmentation, topic modeling, and the like to generate a text vector representation of a text portion.

The text vectorization model 258 may be implemented using a neural network (NN) based architecture including but not limited to deep neural networks (DNN), convolutional neural networks (CNN), graph neural networks (GNN) and the like.

In one or more embodiments, the text vectorization model 258 may be implemented as an encoder to generate the embedding vector of text portions in the form of encoded text portions. As a non-limiting example, the text vectorization model 258 may be implemented as an encoder of the dialogue generation model 252.

Non-limiting examples of embedding models include word2vec, sentence2vec, doc2vec, Stanford University's GloVe, AllenNLP's Elmo, fastText, as well as transformer-based language models such as XLNet, Bidirectional Encoder Representations from Transformers (BERT), and Generative Pre-trained Transformers (GPT) to generate semantic representations.

Knowledge Retrieval Models

The set of ML models 240 comprises knowledge retrieval models 261, the knowledge retrieval models 261 comprising a query generation model 262, an embedding similarity model 263, a keyword extraction model 264, and a knowledge-based question-answering (KBQA) model 265.

Query Generation Model

The query generation model 262 is a DNN having been trained to generate queries based on textual information.

In one or more embodiments, the query generation model 262 is based on a transformer model. Non-limiting examples of query generation model 262 includes OpenAI GPT3-based models.

The query generation model 262 is configured to receive as an input a text comprising one or more word/sentences and generate a query representing the text.

In the context of the present technology, the query generation model 262 is used to generate a query given a conversation context, the conversation context being a conversation thread comprising one or more messages (e.g., between users and/or bots) about a subject.

Embedding Similarity Model

The embedding similarity model 263 is a DNN having been trained to determine similarity of text portions based on a distance thereof in embedding space. In one or more embodiments, the embedding similarity model 263 may also generate the vectors of the text portions in embedding space before determining their similarity based on a distance.

It will be appreciated that the text portions may include words, sentences and/or paragraphs. A non-limiting example of embedding similarity models that could be used include ELMo and KeyBERT.

As a non-limiting example, similarity may be determined by calculating a cosine distance between vectors representing the text portions in embedding space.

Keyword Extraction Model

The keyword extraction model 264 is a DNN having been trained to extract keywords from text portions (e.g., sentences and/or paragraphs).

Non-limiting examples of keyword extraction models that may be used include extRank, TopicRank, KeyBERT, YAKE, RAKE, EmbedRank, WordAttraction Rank, PositionRank, ExpandRank, and Multi-word Keyword Scoring Strategy.

It will be appreciated that in some embodiments of the present technology, the keyword extraction model 264 may be replaced by non-machine learning techniques, such as information retrieval (IR) techniques known in the art, to perform extraction of keywords from text portions.

Knowledge-Based Question Answering (KBQA) Model

The KBQA model 265 is a machine learning model having been trained to generate answers in response to questions.

The KBQA model 265 is configured to inter alia: (i) receive a question; (ii) recognizing the subject in the question and linking it to an entity in a knowledge database (e.g., knowledge database 270); (iii) predict an answer within a knowledge base neighborhood of the topic entity.

In one or more embodiments, to predict the answer, the KBQA model 265 may execute a parsed logic form, using semantic parsing-based methods (SP-based methods), which follow parse-then-execute paradigm. In one or more other embodiments, to predict the answer, the KBQA model 265 may execute reasoning in a question-specific graph extracted from the knowledge database 270 and rank all the entities in the extracted graph based on their relevance to the question, using information retrieval-based methods (IR-based methods), which follow a retrieval-and-rank paradigm.

A survey of KBQA including examples of KBQA models 265 is available in paper by Lan, Yunshi, et al. “A survey on complex knowledge base question answering: Methods, challenges and solutions.” arXiv preprint arXiv:2105.11644 (2021).

In one or more embodiments, one or more of the set of ML models 240 may have been previously initialized, and the training server 230 may obtain the set of ML models 240 from the database 235, or from an electronic device connected to the communication network 280.

In one or more other embodiments, the training server 230 obtains the set of ML models 240 by performing a model initialization procedure to initialize the model parameters and model hyperparameters of the set of ML models 240.

The model parameters are configuration variables of a machine learning model, and which are estimated or learned from training data, i.e., the coefficients are chosen during learning based on an optimization strategy for outputting a prediction according to a prediction task.

In one or more embodiments, the training server 230 obtains the hyperparameters in addition to the model parameters for the set of ML models 240. The hyperparameters are configuration variables which determine the structure of the set of ML models 240 and how the set of ML models 240 is trained.

Non-limiting examples of hyperparameters include one or more of: a number of hidden layers and units, an optimization algorithm, a learning rate, momentum, an activation function, a batch size, a number of epochs, dropout, and the like.

In one or more embodiments, training of the set of ML models 240 is repeated until a termination condition is reached or satisfied. As a non-limiting example, the training may stop upon reaching one or more of: a desired accuracy, a computing budget, a maximum training epochs, a lack of improvement in performance, and the like.

In one or more embodiments, the training server 230 may execute one or more of the set of ML models 240. In one or more alternative embodiments, one or more of the set of ML models 240 may be executed by another server (not depicted), and the training server 230 may access the one or more of the set of ML models 240 for training or for use by connecting to the server via an API 268, and specify parameters of the one or more of the set of ML models 240, transmit data to and/or receive data from the ML models 240, without directly executing the one or more of the set of ML models 240.

As a non-limiting example, one or more ML models of the set of ML models 240 may be hosted on a cloud service providing a machine learning API.

Database

A database 235 is communicatively coupled to the STS server 220, the training server 230 and the client device 216 via the communications network 280 but, in one or more alternative implementations, the database 235 may be directly coupled to the training server 230 or the space-time service server 220 without departing from the teachings of the present technology. Although the database 235 is illustrated schematically herein as a single entity, it will be appreciated that the database 235 may be configured in a distributed manner, for example, the database 235 may have different components, each component being configured for a particular kind of retrieval therefrom or storage therein.

The database 235 may be a structured collection of data, irrespective of its particular structure or the computer hardware on which data is stored, implemented or otherwise rendered available for use. The database 235 may reside on the same hardware as a process that stores or makes use of the information stored in the database 235 or it may reside on separate hardware, such as on the training server 230, or the space-time service server 220. The database 235 may receive data from the training server 230 or the space-time service server 220 for storage thereof and may provide stored data to the training server 230 or the space-time service server 220 for use thereof.

In one or more embodiments, the database 235 may store ML file formats, such as .tfrecords, .csv, .npy, and .petastorm as well as the file formats used to store models, such as .pb and .pkl. The database 270 may also store well-known file formats such as, but not limited to image file formats (e.g., .png, .jpeg), video file formats (e.g., .mp4, .mkv, etc), archive file formats (e.g., .zip, .gz, .tar, .bzip2), document file formats (e.g., .docx, .pdf, .txt) or web file formats (e.g., .html).

In one or more embodiments of the present technology, the database 235 is configured to store inter alia: (i) user interactions on the platform including posted messages, viewed posts, and other types of statistics; (ii) tracked data about conversational agents including posted messages, interesting posts to their knowledge background, and other types of statistics. (iii) training datasets for training one or more of the set of ML models 240; and (iv) parameters and hyperparameters of the set of ML models 240.

Knowledge Source Database

One or more knowledge sources represented collectively by knowledge database 270 are communicatively coupled to the training server 230 via the communications network 280 but, in one or more alternative implementations, the knowledge database 270 may be directly coupled to the training server 230 without departing from the teachings of the present technology. Although the knowledge database 270 is illustrated schematically herein as a single entity, it will be appreciated that the knowledge database 270 may be configured in a distributed manner, for example, the knowledge database 270 may have different components, each component being configured for a particular kind of retrieval therefrom or storage therein. It will be appreciated that one or more of the knowledge databases in the knowledge database 270 may be operated and/or owned by a different entity.

The knowledge database 270 may be a structured collection of data, irrespective of its particular structure or the computer hardware on which data is stored, implemented or otherwise rendered available for use. The knowledge database 270 may reside on the same hardware as a process that stores or makes use of the information stored in the knowledge database 270 or it may reside on separate hardware, such as on the training server 230. The knowledge database 270 may receive data from the training server 230 or the conversational agents engine 250 for storage thereof and may provide stored data to the training server 230 or the conversational agents engine 250 for use thereof.

In one or more embodiments of the present technology, the knowledge database 270 is configured to store inter alia: (i) articles including text and multimodal data about entities including historical characters and points of interests (POI); (ii) data about historical characters including, without limitation, events, time, locations, and persona information; and (iii) knowledge graphs relating to the historical characters.

Non-limiting examples of knowledge sources that may be part of the knowledge databases in the knowledge database 270 include public databases such as Wikipedia™, Wikiquotes, WikiData, DBpedia, Freebase, Notable Names Database (NNDB), Stanford Question Answering Database (SQUAD), and the like.

Communication Network

In one or more embodiments of the present technology, the communication network 280 is the Internet. In one or more alternative non-limiting embodiments, the communication network 280 may be implemented as any suitable local area network (LAN), wide area network (WAN), a private communication network or the like. It will be appreciated that implementations for the communication network 280 are for illustration purposes only. How a communication link 285 (not separately numbered) between the plurality of client devices 210, the STS server 220, the training server 230, the conversational agent engine 250, the database 235, the knowledge database 270 and/or another electronic device (not shown) and the communication network 280 is implemented will depend inter alia on how each electronic device is implemented.

The communication network 280 may be used in order to transmit data packets amongst the plurality of client devices 210, the STS server 220, the training server 230, the conversational agent engine 250, the database 235, and the knowledge database 270. For example, the communication network 280 may be used to transmit requests from the training server 230 to the knowledge database 270. In another example, the communication network 280 may be used to transmit information from the training server 230 to the STS server 220.

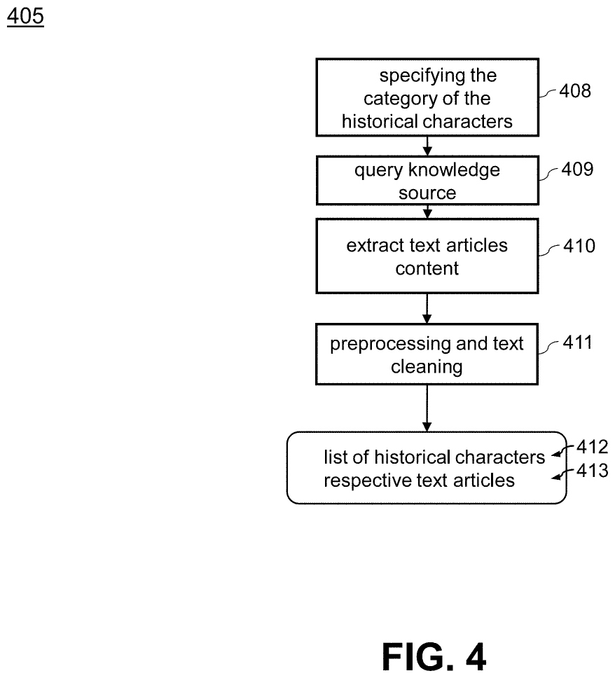

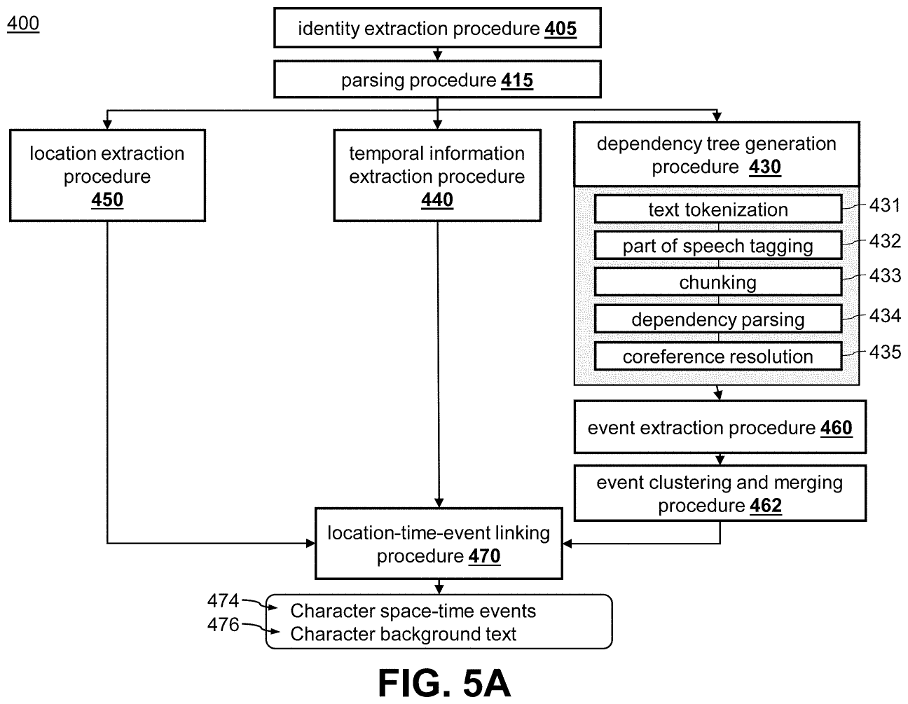

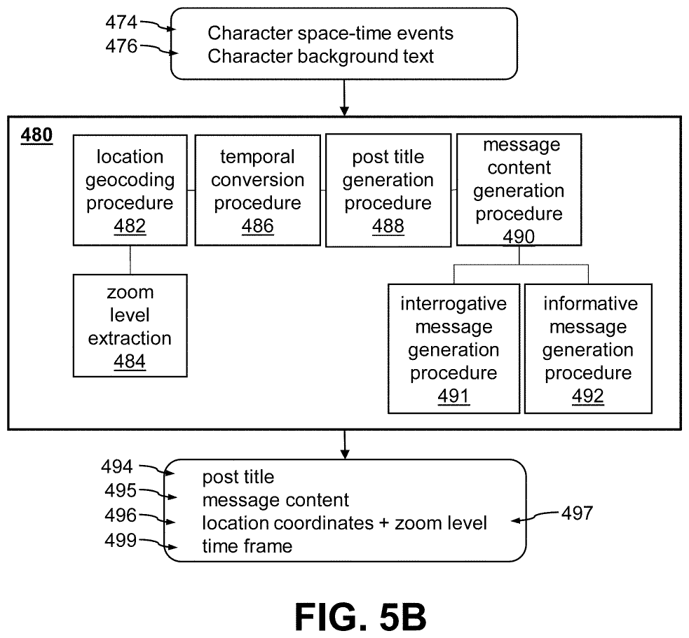

Reference is now made to FIG. 4, FIG. 5A and FIG. 5B, which describes how historical data is extracted from the knowledge database 270 for inter alia training dialogue generation models 252 to impersonate different historical characters. While the following is described for historical characters, it will be appreciated that it may be used for other types of characters, such as imaginary characters in fiction and/or video game characters.

Historical Data Extraction Procedure

With reference to FIGS. 5A-5B, there is shown a schematic diagram of a historical data extraction procedure 400 in accordance with one or more non-limiting embodiments of the present technology.

The purpose of the historical data extraction procedure 400 is to obtain, from external knowledge sources such as the knowledge database 270, information about historical characters and extract events, spatial information (i.e., locations) and temporal information (i.e., dates and time periods) associated with the historical characters which will be used by conversational agents to generate natural language conversations on the STS engine 222.

In one or more embodiments of the present technology, the training server 230 executes the historical data extraction procedure 400. In alternative embodiments, the training server 230 may execute at least a portion of the historical data extraction procedure 400, and one or more other servers such as the STS server 220 may execute other portions of the historical data extraction procedure 400.

The training server 230 has access to the event recognition model 260, the time recognition model 256 and the location recognition model 254. Each of the event recognition model 260, the time recognition model 256 and the location recognition model 254 may have been previously trained, and are configured to perform respectively event recognition, temporal information recognition and space information recognition in text.

During the historical data extraction procedure 400, the training server 230 connects to the knowledge database 270 over the communication network 280. As stated previously, the knowledge database 270 may include one or more different knowledge sources comprising structured and/or unstructured data.

Non-limiting examples of knowledge sources include Wikipedia™, DBpedia, Freebase, Notable Names Database (NNDB), and the like.

Character Identity Extraction Procedure

With brief reference to FIG. 4, during the historical data extraction procedure 400, the training server 230 is configured to perform an identity extraction procedure 405, during which it obtains a list of historical characters from the knowledge database 270.

In one or more embodiments, the training server 230 specifies a category of historical characters 408 to the knowledge database 270 and performs querying 409 of the knowledge database 270 to obtain the list of historical characters associated with the provided category. As a non-limiting example, the category of characters may include famous travellers and explorers, politicians, writers, artists, musicians, and the like. It is contemplated that the training server 230 may further filter the list of historical characters by location, time period, and other criteria. It will be

In one or more embodiments, the training server 230 obtains and performs extraction of a respective article 410 about the character for each character of the list of historical characters. The respective article may include as a non-limiting example an encyclopedia entry, such as a Wikipedia™ page about the character.

It will be appreciated that the respective article may comprise multimodal data such as text, images, videos, and a combination thereof. In one or more other embodiments, the respective article may for example be in the form of a biographical video about the character, from which text data may be extracted. It will be appreciated that the text may be in a different language and may be translated to obtain the respective text portion about the character background in the respective article.

In one or more embodiments, the training server 230 performs preprocessing and text cleaning 411 of the respective text articles associated with each historical character to obtain the respective text portions.

By executing the identity extraction procedure 405, the training server 230 thus obtains a list of historical characters 412 which will be used as the conversational agent identities, as well as a respective text article 413 for each historical character. Each historical character will correspond to an identity of a conversational agent, i.e., a conversational agent will be deployed for each historical character.

Turning back to FIG. 5A, the training server 230 is then configured to execute a parsing procedure 415, during which the training server 230 parses, for each character identity, the associated raw text portion about the character background in the respective article. In one or more embodiments, during the parsing procedure 415, the respective article is divided into different sections. For example, the respective article may be divided into paragraphs and sentences to obtain the text portions associated with the historical characters background.

The training server 230 is then configured to perform a dependency tree generation procedure 430 to generate one or more dependency trees for each historical character based on the associated text portion.

In one or more embodiments, the dependency tree generation procedure 430 comprises text tokenization 431, part of speech tagging 432, chunking 433, dependency parsing 434 and coreference resolution 435 to obtain parsed dependency trees.

The dependency tree details the connections and relations between the tokens or syntactic units (i.e., words) in a sentence. It will be appreciated that the dependency tree is in the form of a directed graph representation, in which words in the sentence are nodes in the graph and grammatical relations are edge labels.

In one or more embodiments, during the dependency tree generation procedure 430, the training server 230 uses natural language processing and computational linguistics techniques and may access named entity recognition (NER) algorithms libraries such as NLTK, Spacy or Stanford-CoreNLP, and the like.

The training server 230 generates a dependency tree of each sentence with part-of-speech (POS) tags and syntactic dependencies. POS tags may include:
ADJ: adjective
ADP: adposition
ADV: adverb
AUX: auxiliary verb
CONJ: coordinating conjunction
DET: determiner
INTJ: interjection
NOUN: noun
NUM: numeral
PART: particle
PRON: pronoun
PROPN: proper noun
PUNCT: punctuation
SCONJ: subordinating conjunction
SYM: symbol
VERB: verb
X: other

The training server 230 performs coreference resolution to obtain the dependency tree for the given historical character, i.e., the training server 230 finds all linguistic expressions (mentions) in a given text portion that refer to the same real-world entity.

After performing the dependency tree generation procedure 430 to obtain one or more dependency trees for a given historical character, the training server 230 is configured to perform the event extraction procedure 460 to extract events based on the dependency trees. During the event extraction procedure 460, the training server 230 uses the event recognition model 260 to extract the historical character span (PROPN) or proper noun, and extracts the depending verb spans and the subsequent tokens which are labeled as events.

The training server 230 performs event clustering and merging procedure 462 to obtain a set of events comprising one or more events for each historical character. During the event clustering and merging procedure 462, the set of extracted events are grouped into an agglomerative set of events to avoid posting about similar events belonging to the same parent event.

The training server 230 is configured also to perform the location extraction procedure 450 and the temporal information extraction procedure 440 to extract space (location) information and temporal information. During the location extraction procedure 450, the training server 230 uses the location recognition model 254 to extract spatial information or locations from text. During the temporal information extraction procedure 440, the training server 230 uses the time recognition model 256 to extract temporal information from text.

The training server 230 is configured to perform a location-time-event linking procedure 470, with the outputs of the event clustering and merging procedure 462, the temporal information extraction procedure 440, and the location extraction procedure 450 during which the extracted events are constrained in space and time (also referred to as “spatio-temporal coordinates” or “space-time coordinates”).

It will be appreciated that the location and time granularity may be predetermined, e.g., location information may need to be accurate within a predetermined radius and the temporal information may need to be accurate within a predetermined time period, however this does not need to be so in each and every embodiment of the present technology. The purpose of the procedure is to obtain, for a given time and location, an event or action in a given historical character's life.

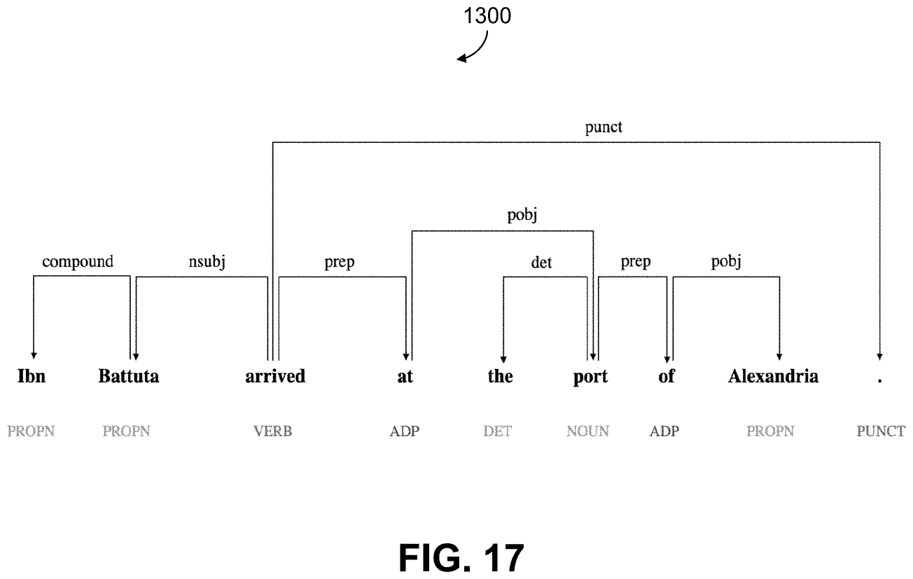

FIG. 17 illustrates a schematic non-limiting example of a dependency tree 1700 of a sentence “In the early spring of 1326, after a journey of over 3,500 km (2,200 mi), Ibn Battuta arrived at the port of Alexandria.”. The dependency tree 1700 has been obtained by performing the dependency tree generation procedure 430.

In this example, the time recognition model 256 extracts the year 1326 as the temporal information, the location recognition model 254 extracts the port of Alexandria as the location information, and the event recognition model 260 extracts the event as being the character Ivan Battuta arriving at the port of Alexandria. For each word in the sentence “In the early spring of 1326, after a journey of over 3,500 km (2,200 mi), Ibn Battuta arrived at the port of Alexandria.”, the dependency tree generation procedure 430 obtains a respective a part-of-speech tag.

Character Data Conversion Procedure

With brief reference to FIG. 5B, a conversion procedure 480 executed after the historical data extraction procedure 400 will now be described.

In one or more embodiments, the training server 230 performs the conversion procedure 480 to convert the extracted data in an appropriate format for compatibility with one or more embodiments of the STS engine 222.

In one or more embodiments, for each location extracted by the location recognition model 254, the training server 230 performs location geocoding procedure 482 to obtain location coordinates 496.

In one or more embodiments, for each extracted location, the training server 230 performs a zoom level extraction procedure 484 to obtain a zoom level 497. The zoom level 497 is the level of granularity associated with the location. The zoom level 497 may, as a non-limiting example, represent a threshold distance (e.g., radius) associated with the location.

In one or more embodiments, the training server 230 performs a temporal conversion procedure 486 to convert the temporal information into a standard format. As a non-limiting example, the training server 230 converts the temporal information into a TIMEX3 format. The training server 230 performs conversion of the temporal information to obtain the timeframe 499. In one or more embodiments, the training server 230 converts TIMEX3 format into a timeframe format.

In one or more embodiments, the training server 230 obtains character background text 476 about the space-time events 474 and/or the respective parsed text portions having been parsed during the parsing procedure 415.

In one or more embodiments, the character background text 476 may be used on the STS engine 222 to post informative messages which may relate to an event or to a specific location and time.

In one or more other embodiments, the character background text 476 may be used by the dialogue generation model 252 to take the identity of the given historical character and to generate messages related to events on the STS engine 222.

In one or more embodiments, the character background text 476 comprises the paragraph from which the parsed sentence comprising the event constrained in space and time has been extracted. The character background text 476 may include additional information about the extracted event which may be used as support data by the conversational agents to generate knowledgeable responses on the STS engine 222.

In one or more embodiments, the training server 230 performs post title generation procedure 488 based on the extracted events to obtain a post title 494. The post title 494 will be used as a title for content generated by the conversational agents on the STS engine 222. In one or more embodiments, post title generation procedure 490 is performed based on the generated message content, character background text, and/or extracted event with associated spatio-temporal coordinates.

In one or more embodiments, the training server 230 performs message content generation procedure 490 to obtain message content 495. In one or more embodiments, message content generation procedure 490 is performed based on the parsed character background text and/or extracted event with associated spatio-temporal coordinates.

In one or more embodiments, to perform message content generation procedure 490, the training server 230 performs at least one of interrogative message generation procedure 491 and informative message generation procedure 492. How the training server 230 performs interrogative message generation procedure 491 and informative message generation procedure 492 will be explained in more detail below.

For an informative message, the message content 495 may include at least a portion of the sentence having been parsed to generate a dependency tree including with spatio-temporal coordinates. The message content 495 may be stored and retrieved to be posted directly on the STS platform 225 when it is determined to be relevant with respect to users interests and trending topics within and outside the platform.

In one or more embodiments, informative message generation 492 may be performed by the training server 230 using one of the ML models in the conversational agent engine 250 such as the dialogue generation model 252 based on at least the character background text 476.

In one or more embodiments, interrogative message generation 491 may be performed by the training server 230 using one of the ML models in the conversational agent engine 250 such as the dialogue generation model 252 based on at least the character background text 476. The message content 495 may be in the form of a question generated by the dialogue generation model 252.

In one or more alternative embodiments, message content generation procedure 490 comprises using persona information of the given historical character. For example, the conversational agent may imitate the writing style of the historical character based on historical character data sources which may be present in the knowledge database 270 or which may be obtained from other databases (not illustrated). The historical character data sources may for example include written material having been written by the given historical character such as books, essays, articles, letters, etc. In one or more embodiments, the written material may include quotes by the character which may be available in the knowledge database 270, e.g., Wikiquotes. Further, in one or more alternative embodiments, the dialogue generation model 243 may be trained to augment its knowledge of the writing style by being trained based on historical data sources which correspond to the time period and social class background of the historical character. The historical character persona is mainly captured in a distributed embedding vector that encodes its individual characteristics such as gender, conversing style, and background facts. These latter are chosen from the set of the space-time life events that were extracted before.

The training server 230 stores, in the knowledge database 270, for each historical character, the event comprising one or more of the character background text 476, the post title 494, and the message content 495, the event being associated with the location coordinates 496 including the zoom level 497 and the timeframe 499.

The stored information will be used by the training server 230 to navigate the STS engine 222, to generate posts or threads on the STS engine 222 and interact with users of the STS engine 222, as will be explained below.

Having explained how historical characters and related historical data including events and character background text are extracted during the historical data extraction procedure 400 by using inter alia the event recognition model 260, the time recognition model 256 and the location recognition model 254, a character relevance determination procedure 600 for selecting conversations in which the conversational agents may engage on the STS engine 222 will now be explained.

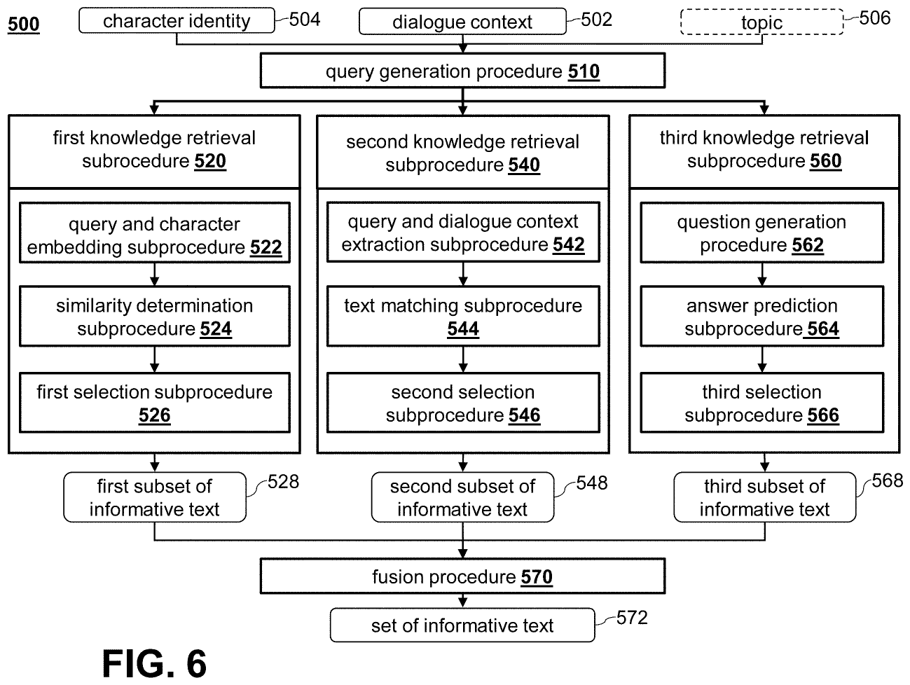

With reference to FIG. 6, there is illustrated a knowledge retrieval procedure 500.

Knowledge Retrieval Procedure

The purpose of the knowledge retrieval procedure 500 is to retrieve relevant knowledge or informative text that will be used to train a dialogue generation model 252 impersonating a given character to generate responses relating to the given character in a dialogue context on a platform (e.g., the STS engine 222). The knowledge retrieval procedure 500 uses the knowledge retrieval models 261.

The knowledge retrieval procedure 500 is configured to output textual information relevant to a given conversation context 502, a character identity 504 and optionally a topic 506.

The given conversation context 502 may be, as a non-limiting example, a message thread comprising one or more messages about a subject, time, event, etc. It will be appreciated that the messages may have been posted by users and/or other AI bots.

The knowledge retrieval procedure 500 receives a given conversation context 502. The given conversation context may comprise a conversation history (i.e., message thread) with one or more messages.

The character identity 504 refers to a character of interest for which the knowledge retrieval procedure 500 will be executed. The character identity 504 may have been determined prior to the knowledge retrieval procedure 500, and may include a character for which background knowledge information is available, such as a historical character or a fictional character (e.g., in literature or video games).

In one or more alternative embodiments, the knowledge retrieval procedure 500 further uses a topic 506. The topic 506 may for example relate to a point of interest (POI) in a location, an event, an object, a time period, etc. The topic 506 may have been determined prior to the knowledge retrieval procedure 500.

The knowledge retrieval procedure 500 performs a query generation procedure 510 to generate, based on the given conversation context 502, the character identity 504, and optionally the topic 506, a respective search query.

In one or more embodiments, the query generation procedure 510 uses a query generation model 262 to generate a search query based on the given conversation context 502. The query generation model 262 may generate the query further based on the character identity 504 and optionally the topic 506. In one or more embodiments, the query generation model 262 comprises a transformer model having been trained to generate search queries.

A non-limiting example of a query generated based on a given conversation context, a character identity and topic may be “Publication date of the theory of relativity Albert Einstein”.

In one or more other embodiments, the query generation procedure 510 generates a query based on the given conversation text using another type of technique or method.

The search query represents the conversation context. The search query will be used to retrieve knowledge text for training the dialogue generation model 252 impersonating a character to generate responses to a conversation thread on a platform such as the STS platform 225.

The knowledge retrieval procedure 500 uses results output by one or more of a first knowledge retrieval subprocedure 520, a second knowledge retrieval subprocedure 540, a third knowledge retrieval subprocedure 560. In one or more embodiments, the knowledge retrieval procedure 500 may execute at least two of the first knowledge retrieval subprocedure 520, the second knowledge retrieval subprocedure 540 and the third knowledge retrieval subprocedure 560

First Knowledge Retrieval Subprocedure

The first knowledge retrieval subprocedure 520 comprises a search query and character embedding subprocedure 522, a similarity determination subprocedure 524 and a first selection subprocedure 526.

The search query and character embedding subprocedure 522 receives the search query, and generates a dense vector embedded in a continuous space, the dense vector representing the search query.

The search query and character embedding subprocedure 522 obtains, from the knowledge database 270, based on the character identity 504, a textual description of the character. As a non-limiting example, for a historical character, the knowledge database 270 may include one or more Wikipedia articles about the character. It will be appreciated that other types of textual description of the character may be used.

The search query and character embedding subprocedure 522 then uses the text vectorization model 258 (or another ML model) to embed the sentences of the textual description associated to the character to obtain an embedded vector (i.e., a low-dimensional dense representation) of the textual description associated with the character. In one or more embodiments, search query and character embedding subprocedure 522 further obtains a textual description associated with the point of interest (POI) related to the character and generates an embedding thereof.

The first knowledge retrieval subprocedure 520 then performs a similarity determination subprocedure 524 to determine a degree of similarity between the search query and sentences in the character description. In one or more embodiments, the similarity determination subprocedure 524 calculates a distance between the embedded search query and the embedded sentences of the character text in the low-dimensional space. It will be appreciated that in the embedding space, vectors that are located closer to each other are indicative of a semantic or conceptual similarity, while vectors located a longer distances are indicative of a low degree of semantic or conceptual similarity.

In one or more embodiments, the first knowledge retrieval subprocedure 520 uses an embedding similarity model 263 having been trained to determine similarity of embeddings based on a distance thereof. It will be appreciated that in some embodiments, the embedding similarity model 263 may be used to generate the embeddings and determine their similarity.

As a non-limiting example, the similarity determination subprocedure 524 may calculate a cosine distance between the embedded search query (i.e., search query vector) and the embedded character text sentences (i.e., sentences vector(s)).

The first knowledge retrieval subprocedure 520 then executes a first selection subprocedure 526 to rank the sentences according to their distances from the search query in the embedding space, where a lower distance is indicative of a higher similarity (relevance) to the search query. The first selection subprocedure 526 selects a predetermined number of sentences in the ranked sentences. In one or more alternative embodiments, the first selection subprocedure 526 selects sentences based on a distance threshold.

As a non-limiting example, the first knowledge retrieval subprocedure 520 obtains the top 3 ranked sentences representing the sentences lying closer to the embedded search query in the embedding space.

The first knowledge retrieval subprocedure 520 outputs a first subset of informative text 528. The first subset of informative text 528 comprises a set of sentences relevant to the search query.

Second Knowledge Retrieval Subprocedure

The second knowledge retrieval subprocedure 540 comprises a search query and dialogue context extraction subprocedure 542, a keyword matching subprocedure 544 and a second selection subprocedure 546.

The search query and dialogue context extraction subprocedure 542 is configured to extract relevant keywords from each of the search query and the conversation context. The second knowledge retrieval subprocedure 540 obtains search query keywords and conversation context keywords.

In one or more embodiments, the search query and dialogue context extraction subprocedure 542 uses a keyword extraction model 264 to extract keywords from the search queries based on the dialogue context 502, the character identity 504 (and associated text) and optionally the topic 506.

In one or more other embodiments, the search query and dialogue context extraction subprocedure 542 is configured to use information retrieval (IR) techniques to perform keyword extraction from the character article. Non-limiting examples of such techniques include word frequency, word collocations and co-occurrences, term frequency—inverse document frequency (TF-IDF), Rapid Automatic Keyword Extraction (RAKE).

The keyword matching subprocedure 544 receives keywords from the search query and the dialogue context, and performs matching with the character text. The character text is obtained based on the based on the character identity 504, for example from the knowledge database 270.

In one or more embodiments, the keyword matching subprocedure 544 matches the query and context keywords with the character text (e.g., Wikipedia article) using the intersection of the keywords.

In one or more embodiments, the second knowledge retrieval subprocedure 540 further matches the search query keywords and conversation context keywords with keywords in the textual description of the POI.

The second knowledge retrieval subprocedure 540 executes the second selection subprocedure 546 to rank the character sentences according to the keyword intersections.

The second selection subprocedure 556 selects a predetermined number of sentences in the ranked sentences. In one or more alternative embodiments, the second selection subprocedure 526 selects sentences based on a distance threshold.

The second knowledge retrieval subprocedure 540 obtains a set of candidate sentences, the set of candidate sentences being relevant to the search query keywords and conversation context keywords.

The second knowledge retrieval subprocedure 540 outputs a second subset of informative text 448 comprises a set of sentences relevant to the search query.

Third Knowledge Retrieval Subprocedure

The third knowledge retrieval subprocedure 560 comprises a query generation procedure 562, an answer prediction subprocedure 564 and a third selection subprocedure 566.

The query generation procedure 562 is configured to transform the search query into a question. In one or more embodiments, the query generation procedure 562 uses a query generation model 262 to transform the search query into a question. In one or more embodiments, the query generation model 262 is implemented as a transformer model.

The answer prediction subprocedure 564 is configured to access a knowledge-based question-answering (KBQA) model (not illustrated) to provide (predict) an answer to the question. The KB QA model is a machine learning model having been trained to provide answers in response to questions. The KBQA model enables finding short concrete text segments that would answer a user question or contain the relevant information to generate the next response. The KBQA model outputs a candidate answer to the question generated based on the search query.

The third selection subprocedure 566 outputs one or more answers provided by the KBQA model in response to the question having been generated based on the search query.

The third selection subprocedure 566 outputs a third subset of informative text 468 comprises a set of sentences relevant to the search query.

It will be appreciated that each of the first subset of informative text 438, the second subset of informative text 448 and the third subset of informative text 468 comprises informative sentences relevant to the dialogue context 502 having been obtained by using respectively the first knowledge retrieval subprocedure 520, the second knowledge retrieval subprocedure 540, the third knowledge retrieval subprocedure 560. The use of the knowledge retrieval subprocedures 520, 540, 560 enables varying the type of knowledge that is obtained due different techniques being used. It will be appreciated that sentences from the first subset of informative text 438, the second subset of informative text 448 and/or the third subset of informative text 468 may intersect.

Fusion Procedure

The knowledge retrieval procedure 500 executes a fusion procedure 570.

The fusion procedure 570 receives the first subset of informative text 438, the second subset of informative text 448 and the third subset of informative text 468. The fusion procedure 570 is configured to combine at least two of the first subset of informative text 438, the second subset of informative text 448 and the third subset of informative text 468 to obtain the set of informative text 572.

In one or more embodiments, the fusion procedure 570 combines the outputs of at least two of the first knowledge retrieval subprocedure 520, the second knowledge retrieval subprocedure 540, the third knowledge retrieval subprocedure 560.

The knowledge retrieval procedure 500 outputs the set of informative text 572 comprising a set of candidate knowledge sentences relevant to a conversation context, the set of candidate knowledge sentences having been generated by using the first knowledge retrieval subprocedure 520, the second knowledge retrieval subprocedure 540, and the third knowledge retrieval subprocedure 560.

It will be appreciated that combining results from different knowledge retrieval subprocedures enables obtaining knowledge text data that is more diversified than knowledge data obtained from a single subprocedure, which will enable training the dialogue generation model 252 impersonating a character to generate more diversified responses than responses generated by training the dialogue generation model 252 based on only one knowledge retrieval subprocedure.

The knowledge retrieval procedure 500 may be repeated for different dialogue contexts and different characters and stored in the database 235.

The set of informative text 572 with the dialogue context 502 is used to train the dialogue generation model 252 impersonating a character to generate responses in a dialogue on a platform such as the STS platform 225.

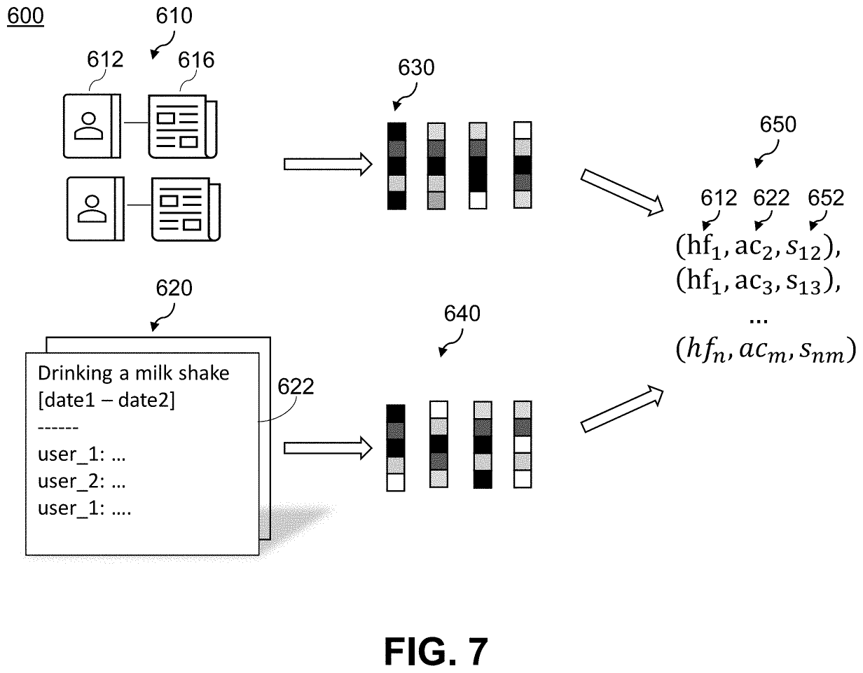

With reference to FIG. 7, a character relevance determination procedure 600 will now be described in accordance with one or more non-limiting embodiments of the present technology.

The character relevance determination procedure 600 may be executed in some embodiments of the present technology as a procedure to determine relevance of characters to conversations contexts (conversation threads) available on the STS platform 225, such that relevant characters which may be impersonated by conversational agents (i.e., dialogue generation models 252) to participate to conversations on the STS platform 225.

Character Relevance Determination Procedure

In one or more embodiments of the present technology, the training server 230 executes the character relevance determination procedure 600. In one or more other embodiments, the STS system 224 may execute the character relevance determination procedure 600. In one or more alternative embodiments, the training server 230 may execute at least a portion of the character relevance determination procedure 600, and one or more other servers such as the STS system 224 may execute other portions of the character relevance determination procedure 600.

The character relevance determination procedure 600 may be executed at predetermined time intervals (e.g., every day), or may be executed by receiving an indication to do so (e.g., from an operator of the present technology or from another electronic device). The character relevance determination procedure 600 may be executed on the STS engine 222, or by receiving data from the database 235 of the STS engine 222. In one or more alternative embodiments, the active conversation threads 620 are obtained from any other type of service that enables users to interact in space and time such as social media, metaverses, video games, mapping applications and the like.

In one or more embodiments, the training server 230 obtains an indication of geographical coordinates for which to perform the character relevance determination procedure 600. The indication of the geographical coordinates may correspond for example to a specific location related to the historical characters background, an area, a district, a city, a province, etc. Additionally, the training server 230 obtains an indication of temporal information related to the historical characters background, for example a specific date that may refer to the character birthdate, hour or range of hours, days, months, years, etc.

The training server 230 obtains, a list of historical characters 610. Each character of the list of historical characters 610 is associated with indications of the spatial information and temporal information that are reflective of each character background. The list of historical characters 610 includes at least one historical character.

In one or more embodiments, the training server 230 obtains the list of historical characters 610 from the knowledge database 270. In one or more other embodiments, the training server 230 may receive the entire list of historical characters stored in the knowledge database 270.

It will be appreciated that the character relevance determination procedure 600 may be executed on the basis of location ranges (spatial coordinates ranges), time ranges (temporal coordinates ranges), character categories, specific characters, or a combination thereof.

It will be appreciated that the list of historical characters may be a subset of all historical characters having been extracted from the knowledge database 270.

The training server 230 obtains, for each historical character 612 of the list of historical characters, a text portion 616 associated therewith. In one or more embodiments, the text portion 616 is a summary text associated with the historical character 612, which may be a single paragraph summarizing key events in the life of the historical character 612. As a non-limiting example, the summary text may correspond to the first paragraph on top of a Wikipedia™ page. As another non-limiting example, in other embodiments, the summary text may correspond to the entire article.

In one or more other embodiments, the text portion 616 may be generated by a machine learning model having been trained to generate abstracts based on articles about the historical character in the knowledge database 270.

The training server 230 obtains active conversation threads 620. Each active conversation thread, also referred to as a dialogue context, may for example include messages with text forming a dialogue having been posted on the STS engine 222 within a predetermined period of time, and/or having a predetermined number of replies, or having been posted by users having been active on the STS engine 222 within a predetermined period of time. The active conversation threads 620 may include messages posted in a text format, locations and timestamps associated with the messages. In one or more alternative embodiments, the active conversation threads may include all conversation threads in the STS engine 222. A given active conversation thread 620 comprises a set of messages that are grouped based on at least one topic.

The active conversation threads 620 may be obtained based on the indication of spatial information.

In one or more embodiments, the active conversation threads 620 are obtained from the STS server 220. In one or more alternative embodiments, the active conversation threads 620 are obtained from any other type of service that enables users to interact in space and time such as social media, metaverses, video games, mapping applications and the like. It is contemplated that the STS engine 222 may be part of such services.

The training server 230 uses the text vectorization model 258 to generate: (i) an encoded text portion 630 of the text portion 616 associated with each historical character; and (ii) an encoded active conversation thread 640 of the active conversation threads 620.

In one or more alternative embodiments, the training server 230 considers each reply in an active conversation thread individually, and thus generates a vector for each reply in the active conversation thread, with each reply vector being associated together.

In one or more embodiments, the encoded text portion 630 and the encoded active conversation thread 640 are represented in the form of embeddings or vectors in a multidimensional space. This representation enables comparing the text portion summarizing the character background and text included in the active conversation threads 620.

Thus, the training server 230 obtains, for each historical character 612, an encoded text portion 630. The training server 230 obtains, for each active conversation thread 620, an encoded active conversation thread 640.

The training server 230 then determines a respective similarity score between a given encoded text portion 630 associated with a given historical character 612 and each encoded active conversation thread 640. It will be appreciated that the training server 230 may obtain a respective similarity score between each historical character in the list and each active conversation thread.

The similarity score may be for example a semantic similarity score which is indicative of how similar the given encoded text portion 630 and the encoded active conversation thread 640 are to each other. The similarity score may take into account the encoded space and time coordinates for each of the historical character and the conversation thread.

In one or more embodiments, the similarity score is determined by calculating a distance between the encoded summary text and the encoded conversation thread in the multidimensional space. As a non-limiting example, the similarity score may be determined by calculating a cosine similarity.

In one or more other embodiments, the encoding and the similarity score calculation may both be performed by using a machine learning model having been trained to encode text portions based on features thereof and to determine similarity scores between the encoded text portions.

The character relevance determination procedure 600 thus obtains a list of context similarity scores 650, where each similarity score is indicative of a similarity between a given text portion associated with a historical character and a given active conversation thread.

During the character relevance determination procedure 600, the training server 230 determines if each similarity score 652 is above a threshold. The threshold may be a static threshold or may be a dynamic threshold. It will be appreciated that the threshold may be set by an operator.

If the similarity score 652 between a given active conversation thread 622 and a given historical character encoded text portion 630 is below the threshold, the given active conversation thread 622 is not selected for further processing as the information about the associated historical character may not be relevant to the given active conversation thread.

If the similarity score 652 between a given active conversation thread 622 and a given historical character encoded text portion 630 is equal to or above the threshold, the given active conversation thread 622 is selected for participation by the conversational agent as the information about the associated historical character 612 is considered to be relevant to the given active conversation thread 622.

An indication of the set of active conversation threads and an indication of historical characters having a similarity score above the threshold are then output.

The dialogue generation model 252 will implement a conversational agent that will take the identity of the historical character to participate in the active conversation thread on the STS engine 222.

Post of Interest Selection and Evaluation Procedure

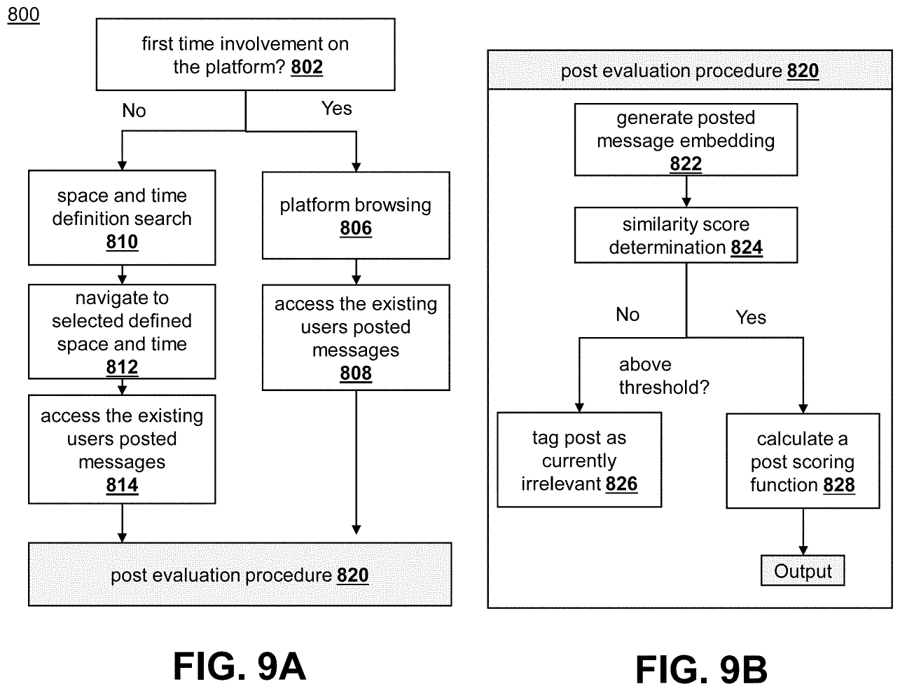

With reference to FIG. 9A and FIG. 9B, an example of the post of interest selection and evaluation procedure 800 will now be described in accordance with one or more non-limiting embodiments of the present technology.

When a new conversational agent taking the identity of a character joins the STS engine 222 for the first time, the agent can explore his world and find relevant posts that might be of interest for the agent (from a biographical perspective) and/or to users of the STS engine 222. To achieve that purpose, the post of interest evaluation procedure 800 is executed such that a conversational agent may “browse” the STS engine 222 to check and evaluate encountered posts. The post of interest selection and evaluation procedure 800 enables the conversational agent to find interesting posts and locate itself in space and time. Once an agent completes this discovery search over the STS engine 222, a narrower search domain in space and time may be defined for each agent.

The post of interest selection and evaluation procedure 800 is executed by the training server 230.

The training server 230 determines if it is the first-time involvement 802 of the conversational agent taking the identity of a given historical character on the STS engine 222. In one or more embodiments, the training server 230 and/or the STS server 220 have a log of historical characters having interacted on the STS engine 222, for example stored in the database 235.

If it is determined that it is the first time the conversational agent having the historical character identity is on the STS engine 222, the training server 230 performs browsing of the whole platform 806. The training server 230 accesses the existing user posted messages 808 on the STS engine 222. In one or more embodiments, the training server 230 accesses the existing user posted messages by receiving the posted messages from the STS engine 222.

If it is determined that it is not the first time the conversational agent having the historical character identity is on the STS engine 222, the training server 230 performs a space and time definition search 810. At this step, the agent starts by exploring his world for the first time to find relevant posts that might interest him. It browses the whole platform to scan and evaluate each encountered post. This can not only help him find interesting posts but also allows him to locate himself in space and time. Once the agents have completed this discovery search over the platform, they attempt later to define a narrow space and time search domain specific to each one of them.

The space and time definition search 810 includes locations and time periods relating to the historical character, for example: places where the character lived with larger scales, places visited, places related to the character's hobbies, birth date, etc. In one or more other embodiments, the space and time definition search 810 can be just a random point in space and time. At each round, a different search domain criterion is chosen for an agent to maximize the probability of finding relevant posts.

The training server 230 then navigates to the selected defined space and time 812. It will be appreciated that the selected defined space and time may be a range defined in space (e.g., area) and time (e.g., specific date range, hour range, etc.).

The training server 230 accesses, for the defined space and time, the existing conversation threads including the existing user posted messages 814. In one or more other embodiments, the training server 230 receives the existing user posted messages 814 from the STS engine 222.

The training server 230 then begins the post evaluation process 820 for each of the existing user posted messages which is then similar to the character relevance determination procedure 600.

During the post evaluation process 820, the training server 230 performs generation of the posted message embedding 822. In one or more embodiments, the training server 230 uses the text vectorization model 258 to generate the posted message embedding 822.

The training server 230 obtains the background of the historical character associated with the conversational agent. In one or more embodiments, the embedding of the background of the conversational agent may have been previously determined, and the training server 230 may obtain the embedding of the background, for example from the knowledge database 270. In one or more alternative embodiments, the training server 230 may generate the embedding of the background of the conversational agent by using the text vectorization model 258.

The training server 230 performs similarity score determination 824 to determine a similarity score between the posted message and the background of the conversational agent.

In response to the similarity score being above the threshold, the training server 230 calculates a post scoring function 828. In one or more embodiments, the post scoring function depends on parameters such as user sentiment analysis, post location, post time, post popularity (e.g., based on number of views, clicks, comments, etc.).

In response to the similarity score being below the threshold, the training server 230 ignores the posted and tags the message as being irrelevant 826.

Thus, the training server 230 tags each post as being relevant or irrelevant for the conversational agent. This information is then stored for future use, as tagging the posts enables to narrow the search domain for the next iteration and “focus” the search for relevant posts of the conversational agent on newly created posts and/or updated irrelevant posts. A post having been previously marked as irrelevant may be re-evaluated if the given conversational agent receives an indication to do so.

Post Triggering Procedure

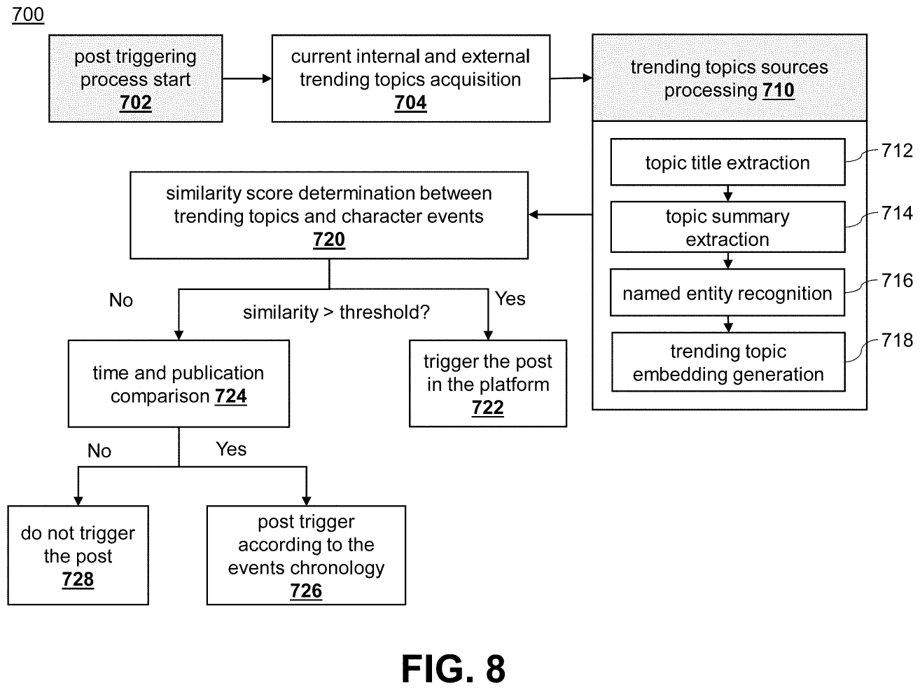

With reference to FIG. 8, a post triggering procedure 700 for conversational agents will now be explained.

The post triggering procedure 700 is executed by the training server 230. The post triggering procedure 700 is executed for each conversational agent taking the identity of a given historical character and enables determining triggers for posting messages on the STS engine 222.

The post triggering procedure 700 is based on the intuition that conversational agents may start their day by checking the current trending news and events in a manner similar to humans. During this check, the agent may “remember” a fact or a particular event that he had lived in the past, which can be an efficient mechanism allowing the agent to revive his “forgotten” memories. In such a case, the conversational agent may decide to trigger a post in the platform about the event or the thought he remembered, to share it with users of the STS engine 222.

The post triggering procedure 700 comprises post triggering process start 702. The post triggering process start 702 may be an indication received at predetermined intervals of time for each conversational agent. As a non-limiting example, the post triggering process start 702 may be a daily indication, e.g., every 24 hours for each conversational agent. In one or more alternative embodiments, the post triggering process start 702 may be another type of indication for example, a specific type of news event, or may be an instruction received from an operator of the system.

The training server 230 performs acquisition of current internal and external trending topics 704.

In one or more embodiments, the training server 230 obtains internal trending topics on the STS engine 222. The internal trending topics may be determined automatically based on number of messages, mentions of words, number of users engaging in conversation threads, etc. In one or more embodiments, the trending topics are received from the database 235.

The external trending topics may be obtained from one or more external sources such as news sources, social media, Wikipedia™ (e.g., current events portal), etc. For example, the training server 230 may obtain the external trending topics via a news API. In one or more other embodiments, the external trending topics may be obtained from the database 235 and/or the knowledge database 270.

The training server 230 performs trending topic sources processing 710. The training server 230 performs extraction of topic titles 712 from the internal and external trending topics.

The training server 230 then performs topic summary extraction 714 based on the topic titles. In one or more embodiments, the topic summary extraction 714 is performed by accessing an entry in the database 235 or in the knowledge database 270 (e.g., Wikipedia™) that is associated with the topic.

The training server 230 performs named entity recognition 716 in the extracted topic summaries. In one or more embodiments, the training server 230 uses the event recognition model 260 to perform named entity recognition to obtain a set of trending events.

The training server 230 then performs trending topic embedding generation 718 for each of the trending events. In one or more embodiments, the training server 230 uses the text vectorization model 258 to generate a respective vector or encoded trending event for each of the set of trending events. In one or more embodiments, the training server 230 uses the text vectorization model 258 to obtain the encoded events. In one or more embodiments, the training server 230 obtains encoded events associated with each historical character from the knowledge database 270.

The training server 230 performs event matching with the embedding trending topics 720 by determining a context similarity score between embedded trending topics 720 and embedded set of events associated with the given historical character for which the post triggering procedure 700 is executed. It will be appreciated that the set of events has been extracted during the historical data extraction procedure 400.

The training server 230 determines a respective similarity score between the encoded trending events and encoded events associated with a historical character. In one or more embodiments, the similarity score is determined by calculating a distance between the encoded trending event and the encoded character events in the multidimensional space. As a non-limiting example, the similarity score may be determined by calculating a cosine similarity.

The similarity score enables evaluating the correlation of each specific event to the agent personifying the historical character with the set of the external trending topics.

If the similarity score is above a threshold, the training server 230 triggers the post in the platform 722.

In one or more embodiments, the training server 230 triggers the post in the platform 722 using a post title 494, a message content 495, location coordinates 496, zoom level 497, and the respective timeframe information 499.

If the similarity score is below the threshold, the training server 230 determines a time elapsed since the last posted message or interaction 724 by the conversational agent personifying the given historical character on the STS engine 222.

If the time elapsed is above the publication period, the training server 230 triggers the post in the platform according to the events chronology 726 of the historical character personified by the conversational agent. It will be appreciated that this enables guaranteeing a steady presence of the conversational agent in the platform. If this matches the first-time presence of the agent in the platform, the agent can just trigger his first ever post according to his own chronological order of events.

If the time elapsed is below the publication period, the training server 230 does not trigger the post 728.

Dialogue Participation Procedure

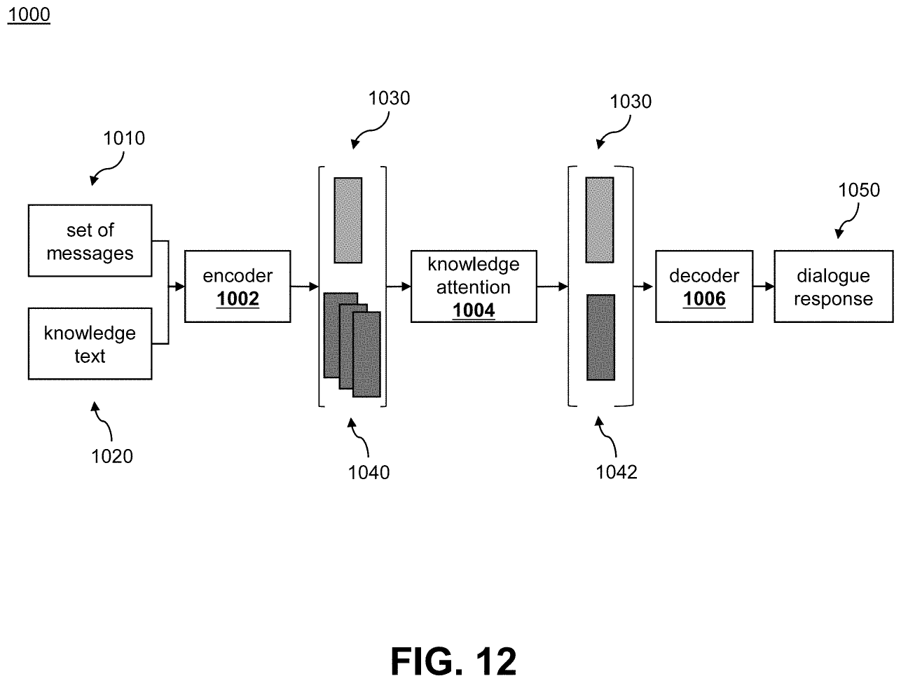

Now turning to FIG. 12, how the dialogue generation model 252 provides a response in the active conversation thread will now be explained with reference to the dialogue participation procedure 1000.

The dialogue participation procedure 1000 is executed by the training server 230 and its output is provided as a reply in a conversation thread. As a non-limiting example, the conversation thread may be a conversation thread on a website such as a social media platform, a video game, or any other type of platform that enable users to interact with space and time coordinates.

The training server 230 obtains a set of conversation threads comprising a set of messages 1010 in the form of a dialogue between users. In one or more embodiments, the set of sentences 1010 is obtained from the STS engine 222.

The dialogue is associated with space-time coordinates and a given topic. It will be appreciated that the dialogue may comprise messages posted by one or more users engaging in a conversation.

The training server 230 obtains supportive knowledge associated with a given historical character. The given historical character may have been previously selected during the character relevance determination procedure 600 based on the similarity score between the text portion associated with the given historical character and the set of sentences 1010.

The supportive knowledge text 1020 is obtained from the knowledge database 270. In one or more embodiments, the supportive knowledge text 1020 is obtained by executing the historical data extraction procedure 400. The supportive knowledge text 1020 comprises one or more sentences associated with the given historical character. Each sentence in the supportive knowledge text 1020 is associated with respective space-time coordinates.

The training server 230 accesses the dialogue generation model 252. The dialogue generation model 252 receives as an input the set of messages 1010 and the supportive knowledge text 1020. More specifically, the encoder 520 of the dialogue generation model 252 receives and encodes each of the set of messages 1010 and the supportive knowledge text 1020 to obtain an encoded set of messages 1030 and encoded candidate knowledge sentences 1040, respectively.

The dialogue generation model 252 then processes the encoded candidate knowledge sentences 1040 by using its knowledge attention mechanism 530 to select one of the encoded candidate knowledge sentences 1040 based on the encoded set of messages 1030 to obtain a selected encoded knowledge sentence 1042.

The selected encoded knowledge sentence 1042 is indicative of information in the supportive knowledge text 1020 being relevant to the topic of the set of messages 1010.

The dialogue generation model 252 uses its decoder 540 to decode the selected encoded knowledge sentence 1042 and the set of encoded messages 1030 to obtain a dialogue response 1050. The dialogue response 1050 is in the form of one or more sentences which may have been written or pronounced by the given historical character and which are relevant to the set of messages 1010.

It will be appreciated that the dialogue response 1050 is generated word-by-word by the dialogue generation model 252 which acts as a conversational agent by taking the identity of the historical character, and the dialogue response 1050 may comprise an original formulation which is based on knowledge extracted from the knowledge database 270. It will be appreciated that the messages may mention events, dates and times relating to the life of the given historical character.

Dialogue Participation Procedure with Persona Information

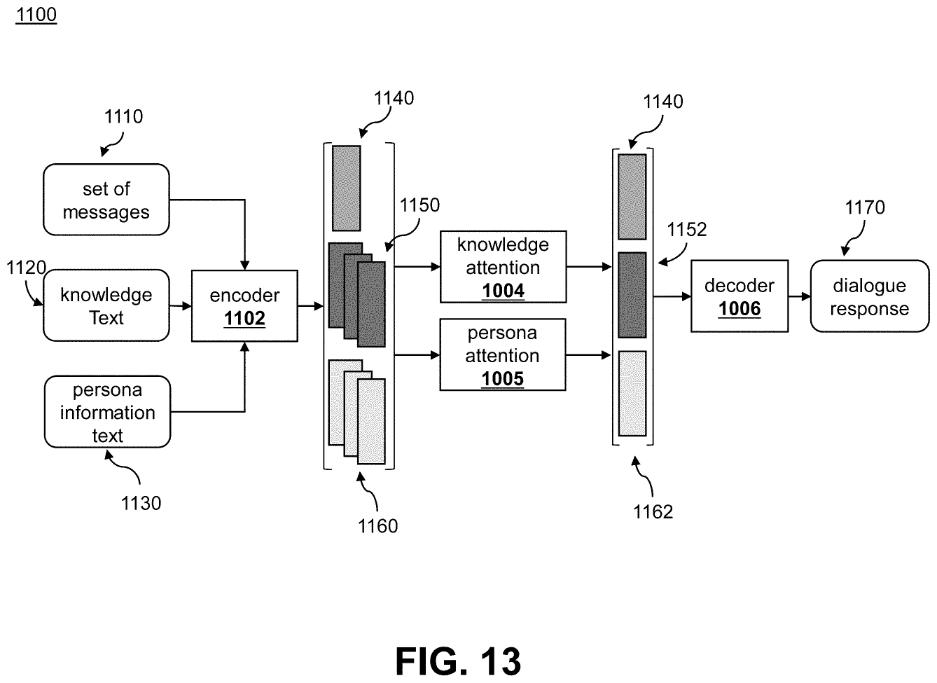

Now turning to FIG. 13, how the dialogue generation model 252 provides a response in the active conversation thread using persona information will now be explained with reference to the dialogue participation procedure with persona information 1100.

Developers of the present technology have appreciated that one of the desirable general qualities of a conversational agent impersonating a character is conducting human-facing dialogues that are engaging, knowledgeable, with a consistent personality. Thus, developers have proposed combining several agent skills to generate appropriate and more personal answers that are conditioned on the background of the character impersonated by the agent. To achieve this, a generative training model (i.e., the dialogue generation model 252) is trained to generate novel answers by conditioning on the dialogue history, the context knowledge, and the character persona. It is to note that the persona attributes can be automatically extracted from the character background text and the earlier recognized events about each historical character can serve as persona indicators. In one or more embodiments, the persona information may be represented using distributed embeddings based on the character's background information. The background information may include for example date of birth, location of birth, occupation, personality type, etc. and speaking style. The speaking style may be extracted from past quotes formulated by the character, which may be available in the knowledge database 270, such as from Wikiquotes.

The overall training model procedure may be executed as follows: based on a dialog history or dialog context, agents are provided with an access to one or more knowledge sources in the knowledge database 270 (e.g., Wikipedia articles). This information along with the dialogue context can be coupled with the historical figure's persona information as input, to be then encoded as individual memory representations in a memory network. A dot-product attention mechanism is used to select the relevant knowledge candidate and the relevant persona information given the dialog history. The information is concatenated and passed to the decoder to yield a dialogue response that is directly grounded with knowledge and persistent persona.

The dialogue participation procedure 1100 is similar to the dialogue participation procedure 1000, however it further comprises use of persona information with a persona attention mechanism. It will be appreciated that the dialogue participation procedure 1100 with persona information may be executed when persona information is available for a given character. In one or more other embodiments, the dialogue participation procedure 1100 becomes the dialogue participation procedure 1000 when persona information is not available.

The dialogue participation procedure 1100 is executed by the training server 230 and its output is provided as a reply in a conversation thread. As a non-limiting example, the conversation thread may be a conversation thread on a website such as a social media platform, a video game, or any other type of platform that enable users to interact with each other in association with space and time coordinates.

The training server 230 obtains a conversation thread (i.e. dialogue context) comprising a set of messages 1110 in the form of a dialogue between users. In one or more embodiments, the set of messages 1110 is obtained from the STS engine 222.

The dialogue is associated with space-time coordinates and a given topic. It will be appreciated that the dialogue may comprise messages posted by one or more users engaging in a conversation.

The supportive knowledge text 1120 is obtained from the database 235 and/or from the knowledge database 270. In one or more embodiments, the supportive knowledge text 1120 is obtained by executing the historical data extraction procedure 400. The supportive knowledge text 1120 comprises one or more sentences associated with the given historical character. Each sentence in the supportive knowledge text 1120 can be associated with respective space-time coordinates.

The training server 230 obtains persona information 1130 associated with a given historical character.

The persona information 1130 includes person attributes extracted from the supportive knowledge text or background information. The background information may include for example date of birth, location of birth, occupation, personality type, etc. and speaking style. The speaking style may be extracted from past quotes formulated by the character, which may be available in the knowledge database 270, such as from Wikiquotes.

Further, some of the recognized events about each historical character extracted during the event extraction procedure 460 can serve as persona indicators. As a non-limiting example, the persona information 1130 may include an indication to use of specific words, sentences, expressions, style of writing, type sentiment (positive, negative, neutral), occupations and the like.

The training server 230 accesses the dialogue generation model 252. The dialogue generation model 252 receives as an input the set of messages 1110, the supportive knowledge text 1120, and the persona information 1130.

More specifically, the encoder 520 of the dialogue generation model 252 receives and encodes each of the set of messages 1110, the supportive knowledge text 1120 and the persona information 1130 to obtain an encoded set of messages 1140, encoded candidate knowledge sentences 1150 and encoded persona information 1160, respectively.

The dialogue generation model 252 then processes the encoded candidate knowledge sentences 1150 by using its knowledge attention mechanism 530 to select one of the encoded candidate knowledge sentences 1150 based on the encoded set of messages 1140 to obtain a selected encoded knowledge sentence 1152.

The selected encoded knowledge sentence 1152 is indicative of information in the supportive knowledge text 1120 being relevant to the topic of the set of messages 1110.

The dialogue generation model 252 processes the encoded persona information text 1160 by using its persona attention mechanism 535 to select one of the encoded persona information sentences 1160 based on the encoded set of messages 1140 to obtain a selected encoded persona information sentence 1162.

The selected encoded persona information 1162 is indicative of information in the persona information text 1130 being relevant to the topic of the set of messages 1110.

The dialogue generation model 252 uses its decoder 540 to decode the selected encoded knowledge sentence 1152 and the selected encoded persona information 1162 to generate a dialogue response 1170. The dialogue response 1170 is in the form of one or more sentences which may have been written or pronounced by the given historical character and which are relevant to the set of messages 1110.

It will be appreciated that the dialogue response 1170 is generated word-by-word by the dialogue generation model 252 which acts as a conversational agent by taking the identity of the historical character and may comprise an original formulation which is based on knowledge extracted from the knowledge database 270 and based on the persona information 1130. It will be appreciated that the messages may mention events, dates and times relating to the life of the given historical character.

Training of the Conversational Agents (Dialogue Generation Models)

In one or more embodiments, the training server 230 performs training of the dialogue generation model 252 based on past dialogues of historical characters on the STS engine 222. In one or more embodiments, past dialogues associated with more user interactions to responses provided by the dialogue generation model 252 may be used as positive examples.

In one or more embodiments, the dialogue generation model 252 uses a generative approach to predict next dialog message. The conversation context, the background knowledge text, and the character persona can be used to generate a response word-by-word.

The dialogue generation model 252 may encode each of the input entities as separate memory representations based on a Transformer encoder, to ensure the preservation of long-term dependency information across time.

The encoder 520 of the dialogue generation model 252 maps the input sequences corresponding to the conversation context, background knowledge text, and character persona information to contextualized encoding sequences.

In one or more embodiments, the dialogue generation model 252 performs different neural attention mechanisms to select the relevant background knowledge text sentences and character persona information that will be used to generate a message.

The dialogue generation model 252 may decode the encoded conversation context, relevant background knowledge and/or character persona information using a Transformer decoder 540 to generate a message. The decoder 540 may have a similar sub-layer as the encoder 520.

In one or more embodiments, the dialogue generation model 252 may be trained to minimize a negative log-likelihood of the dialogue response. A cross-entropy loss function over character background knowledge attention and character persona information attention may be also considered.

Character Dataset Generation

A character dataset generation procedure (not illustrated) may be executed for creating a knowledge augmented dataset of characters dialogues.

The character dataset generation procedure receives a specific character (e.g., specific historical character). The character dataset generation procedure then performs a conversation between a human user and a pretrained conversation model (e.g. a given dialogue generation model 252) fine-tuned to process knowledge segments coming from the knowledge retrieval procedure 500.

The character dataset generation procedure repeats the aforementioned procedure for each character of a list of characters to obtain, for each character, a set of dialogues.

The character dataset generation procedure then generates a training dataset for each character based on the generated set of dialogues. The training dataset may be stored in a storage medium, such as database 235.

The training dataset may then used to train the conversational agent model while incorporating results from the knowledge retrieval procedure 500.

Personalized Conversational Agents for Historical Tourism

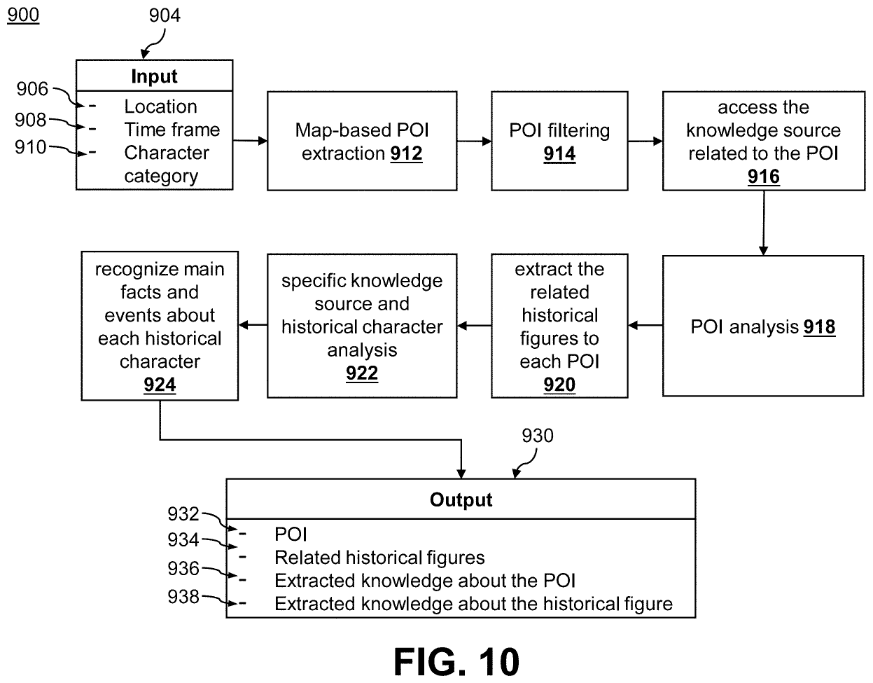

With reference to FIG. 10, a use case of the conversational agents in historical tourism and how information is extracted during a Point Of Interest (POI) and historical figure extraction procedure 900 will now be described in accordance with one or more non-limiting embodiments of the present technology.

It will be appreciated that the trained conversational agents can go beyond the STS engine 222 and may be customized and integrated in other types of real-world applications, such as, but not limited to, historical tourism. In this context, conversational agents will be mainly responsible to guide users in their journeys. This means that the conversational agents will act as a personal virtual touristic assistance, offering a comfortable solution for those who are eager to explore a city or region by themselves, meet the involved historical figures, and know all the history behind.

In one or more embodiments, a user such as user 218 interacting on the STS engine 222 via a respective client device 216 may want to learn more about a point of interest (POI) in a new city or region.

Developers of the present technology have appreciated that trained conversational agents personifying historical figures would be the most appropriate entities to discuss and enlighten users about points of interests (POIs) they may have built, lived in, discovered, or interacted with in their real life.

In one or more embodiments, one of the users such as user 218 having its respective client device 216 may for example be in physical proximity of a POI and may be notified of different historical characters that are associated with his current location. The user 218 will then choose a particular historical figure based on his preferences and start a meaningful conversation together. During the conversation, the conversational agent impersonating a character can discuss some facts about this specific location, suggest to the user 218 to visit another point of interest to discover the city, or invite to the conversation, another agent personifying another historical figure if his background is deemed relevant to the thread context.

In one or more alternative embodiments, the user 218 may access, via the STS engine 222, interactive routes related to the events in the life of a given historical character in a given city, which may be for example a historical character having interacted with the user 218 in a conversation on the STS engine 222 in the new city or region. The user 218 may have indicated that he or she wanted to learn more information about the given historical character in the city, for example by clicking on a user interface element on the STS engine 222.

In one or more other embodiments, the user 218 may for example interact with a given point of interest on the STS engine 222 associated with an article in the knowledge database 270. A list of historical characters having interacted with the given point of interest and having events in their life related to the given point of interest may be displayed on the STS engine 222 based on the article in the knowledge database 270. The user 218 may choose to interact with and learn more about a given character in the list of characters.

To select historical figures that may be of interest to the user 218, the training server 230 obtains a location 906, a timeframe 908, and a character category 910.

It will be appreciated that the location 906 may be obtained directly from the respective client device 216 of the user 218 and/or from the STS engine 222 or another server (not illustrated). The timeframe 908 may be obtained directly from the respective client device 216 of the user 218, from the database 235 and/or from the STS engine 222 or another server (not illustrated). In one or more embodiments, the time 908 may be determined based on a current time or date.

In one or more embodiments, the timeframe 908 may be obtained such that it corresponds to periods in history that are of interest to the user 218. As a non-limiting example, a given user 218 may be particularly interested in the 20th century period, while another given user may be interested in the 15th century.

In one or more embodiments, the timeframe 908 may be obtained from the respective client device 216 by prompting the user 218. In one or more alternative embodiments, the timeframe 908 may be inferred based on information associated with each of the user 218 that may be indicative of a preference for a given historical period. The information may include information from external sources (e.g., social media) or internal sources (e.g., STS engine 222). In one or more other embodiments, the timeframe 908 may be obtained implicitly or inferred from past actions and interactions of the user 218.

The character category 910 may be obtained from the knowledge database 270 and may be associated with the user. In one or more embodiments, the character category may be obtained from the respective client device 216 by prompting the user 218. In one or more other embodiments, the character category 910 may be inferred based on information associated with each of the users such as 218 that may be indicative of a preference for a given category. The information may include information from external sources (e.g., social media) or internal sources (e.g., STS engine 222).

The training server 230 performs map-based POI extraction 912 based on at least the location 906. In one or more embodiments, the training server 230 performs map-based POI extraction 912 based on the location 906, the timeframe 908, and the character category 910. The training server 230 thus obtains a set of POIs based on the location 906, the timeframe 908, and the character category 910.

The training server 230 performs POI filtering 914 of the set of POIs to obtain a set of filtered POIs for each user. The filtering process acts as an intermediate layer between the identified POIs representing a city and the ones that should be shown to the user 218. The filtering process is mainly based on three criteria: POI category, POI location, and POI timeframe. As for the POI category, the user might be interested in discovering museums, public parks, and/or historical buildings. For the POI location, the filtering is based on how far away the POIs are located from a user's location. Finally, POI timeframe filtering, choses POIs based on their original inception date.

In one or more embodiments, a set of categories of interest may be defined or determined for each POI. The set of categories of interest may include public spaces, museums, events, transport, etc. The POIs may be clustered based on these specified categories, and the ones outside the categories may be discarded.

The training server 230 then accesses information from the knowledge database 270 that is related to each POI of the set of filtered POIs. In one or more embodiments, the training server 230 obtains, from the knowledge database 270, text information related to each POIs. As a non-limiting example, the training server 230 may access the Wikipedia page of each given POI.

The training server 230 then performs analysis 918 of each POI information obtained from the knowledge database 270.

The training server 230 performs extraction of related historical figures for each POI. In one or more embodiments, the training server 230 may use NER techniques to extract names of the related historical figures. In one or more alternative embodiments, the historical figures may be listed in the text obtained from the knowledge database 270 for each of the POIs.

In one or more embodiments, the training server 230 determines a score for each character, where the score is indicative of a degree of availability of information such as their birth date, birthplace, occupation, etc. The length of the historical character Wikipedia page is also considered in the scoring process. Thus, a character having a higher score is indicative of a character that has a lot of available information.

The training server 230 performs analysis of the text associated with the historical characters 922 in the knowledge database 270.

In one or more embodiments, the training server 230 performs recognition of main facts and events about each historical character 924.

In one or more embodiments, the training server 230 uses one or more of the event recognition models 260, the time recognition model 256 and the location recognition model 254. In one or more alternative embodiments, the training server 230 uses NER techniques to obtain the facts and events about each historical character.

The training server 230 outputs for each POI 932, related historical figures 934, extracted knowledge about the POI 936 and extracted knowledge about the historical figure 938. The training server 230 may store the outputs in the database 235, in association with each POI or historical character.

In one or more embodiments, the training server 230 generates a knowledge graph of the POI 932 and the historical figures 934.

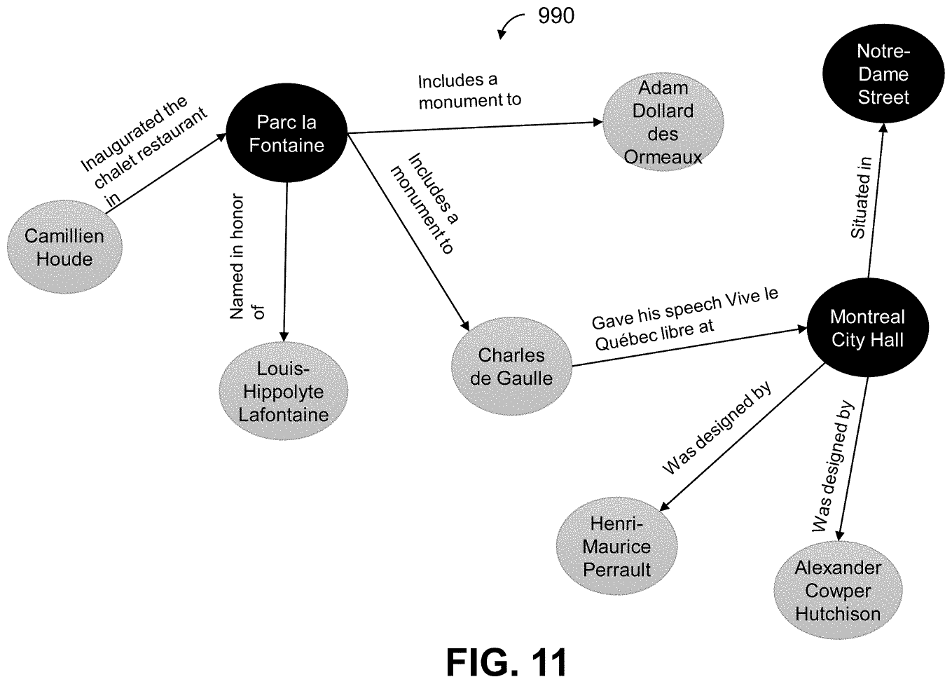

A non-limiting example of a knowledge graph 990 including historical figures and points of interest of the city of Montreal in Quebec, Canada is illustrated in FIG. 11. The knowledge graph 990 may be used as part of a recommendation system that may influence the behaviour of the conversational agents. The knowledge graph 990 represents the background knowledge and organizes the facts about each POI and its relationship to the historical figures for a given space-time range. By exploring the interlinks within the constructed knowledge graph, the connectivity between POIs and historical figures reflects their underlying relationships. Extra POI-historical figure connectivity information derived from KG endows recommender systems the ability of reasoning and explainability. For example, in the context of POI recommendation, if a user is talking to an agent representing Henri-Maurice Perrault and is walking near the Montreal city hall, the agent may for example invite another agent, Alexander Cowper Hutchison to the conversation since they both designed the Montreal city hall POI or the agent may recommend visiting Notre-Dame Basilica de Montreal as it is situated within the same area on Notre-Dame Street. It will be appreciated that the connectivity in the knowledge graph helps agents to reason about unseen or new user-agent interactions by leveraging information from paths. In one or more embodiments, to implement a knowledge-aware recommendation system, a knowledge graph embedding model such as ComplEx may be used to learn symbolic inference rules from relation paths in the knowledge graph. As a result, components with similar connected entities have similar representations in the continuous space, which facilitate the collaborative learning of future recommendations over the graph.

Turning back to FIG. 10, the training server 230 may access, for the given historical character, the events associated with spatio-temporal coordinates stored in the database 235, the events comprising at least one spatial coordinate corresponding to the given point of interest.

The training server 230 may then determine, based on the spatio-temporal coordinates, a route comprising two or more points of interests each related to the events in the life of the given historical character. The route may be determined such that the user 218 may visit different locations comprising the points of interests in a given region, and where the route corresponds to the events having happened in the life of the given historical character chronologically at the specific points of interests.

The training server 230 may deploy the dialogue generation model 252 to take the identity of the given historical character such that the given historical character may act as a tour guide along the determined route and may interact with users via messages on the STS engine 222, for example by describing his life events at different moments in time at the different points of interests. Further, the given historical character may introduce the user 218 to other historical characters located at different points of interests along the determined route.

In one or more embodiments, the dialogue generation model 252 may be trained to learn to imitate the writing style of the historical character based on historical character data sources which may be present in the knowledge database 270 or which may be obtained from other databases (not illustrated). The historical character data sources may for example include written material having been written by the given historical character such as books, essays, articles, letters, etc. Further, the dialogue generation model 252 may be trained to augment its knowledge of the writing style by being trained based on historical data sources which correspond to the time period and social class background of the historical character.

The dialogue generation model 252 may use the supportive knowledge data related to the event stored in the knowledge database 270 to generate messages on the STS engine 222 during the visit. The messages may be informative messages and/or interrogative messages (i.e., questions).

In one or more other embodiments, for generating informative messages, the training server 230 may use text excerpts from the supportive knowledge data instead of the dialogue generation model 252.

It will be appreciated that the text output generated by the dialogue generation model 252 may be converted into audio form via text-to-speech conversion techniques known in the art.

Method Description

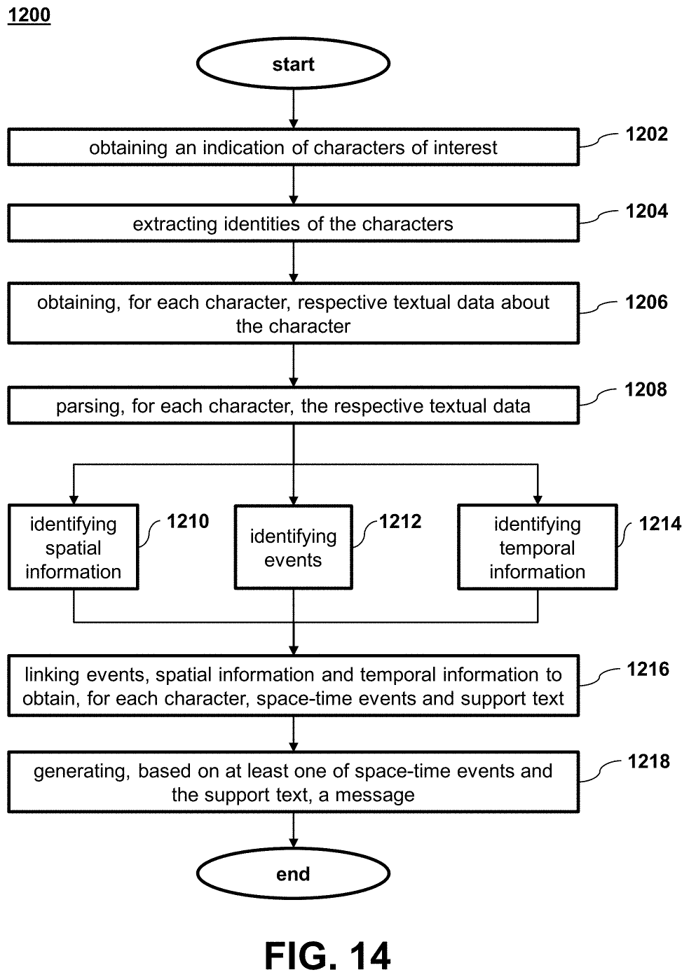

FIG. 14 depicts a flowchart of a method 1200 for extracting historical events associated with historical characters from a knowledge source in accordance with one or more non-limiting embodiments of the present technology.

In one or more embodiments, the training server 230 comprises a processing device such as the processor 110 and/or the GPU 111 operatively connected to a non-transitory computer readable storage medium such as the solid-state drive 120 and/or the random-access memory 130 storing computer-readable instructions. The processing device, upon executing the computer-readable instructions, is configured to or operable to execute the method 1200.

The processing device is connected to and has access to a knowledge source, such as the knowledge database 270. The processing device has access to the event recognition model 260, the time recognition model 256 and the location recognition model 254. The time recognition model 256 and the location recognition model 254 have been previously trained to recognize times (i.e., temporal information) and locations (i.e., spatial information) respectively in text portions. In one or more embodiments, the time recognition model 256 and the location recognition model 254 are implemented as transformer-based models. In one or more embodiments, the processing device has access to further natural language processing models and techniques.

The method 1200 may be used to populate the database 235 such that it can be used to generate messages relating to events in the life of historical characters on the STS engine 222 for interacting with users, such as user 218 interacting on the STS engine 222 via their respective client device 216.

The method 1200 begins at processing step 1202.

At processing step 1202, the processing device obtains an indication of characters of interest. The indication of characters of interest may include, as a non-limiting example, a category of historical characters, a region and/or time period, or a specific type of characters. As a non-limiting example, the category of characters may include famous travellers and explorers, politicians, writers, artists, musicians, and the like. It is also contemplated that the training server 230 may obtain the list of historical characters based on a country, time period, and the like.

In one or more embodiments, the processing device obtains the indication of historical characters of interest from an electronic device connected to the training server 230. As a non-limiting example, the indication of the list of historical characters of interest may be specified by a user or an operator via an electronic device.

In one or more alternative embodiments, the indication of the characters of interest may be determined randomly.

At processing step 1204, the processing device extracts the identities of the characters, based on the indication of the characters of interest. As a non-limiting example, the processing device may query the knowledge database 270 based on the indication, which may be for example a category of historical characters, and the processing device may receive the identities of the characters in the form a list of historical characters.

At processing step 1206, the processing device obtains, for each character of the list of characters, a respective textual data about the character. In one or more embodiments, the processing device obtains the textual data representing character background facts in the form of an article from the knowledge database 270. The article comprises factual biographical information about the life of the historical character.

At processing step 1208, the processing device parses, for each character, the respective article to obtain a parsed article. In one or more embodiments, the processing device performs text cleaning and preprocessing, and divides the respective article into paragraphs and sentences, to obtain a parsed article that is ready to be analyzed.

In one or more embodiments, to execute the parsing of the respective article, the processing device uses natural language processing (NLP) and computational linguistics techniques and may access named entity recognition (NER) algorithms libraries such as NLTK, Spacy or Stanford-CoreNLP, and the like.

At processing step 1210, the processing device uses the location recognition model 254 to identify and extract spatial information or locations in the parsed article.

In one or more embodiments, for each location extracted by the location recognition model 254, the processing device also performs location geocoding 482 to obtain location coordinates.

At processing step 1212, the processing device uses the event recognition model 260 to extract the historical character span (PROPN) or proper noun, and extracts the depending verb spans and the subsequent tokens which are labeled as events.

In one or more embodiments, prior to using the event recognition model 260 to extract events, the processing device generates a dependency tree by performing text tokenization, part of speech (POS) tagging, chunking, dependency parsing and coreference resolution to obtain parsed dependency trees. The event recognition model 260 then extracts the events from each trees and clusters and merges the events to obtain a set of events for each historical character.

At processing step 1214, the processing device uses the time recognition model 256 to identify and extract temporal information from the parsed article.

In one or more embodiments, the processing device converts the temporal information into a standard format.

In one or more embodiments, processing steps 1210, 1212, and 1214 are executed simultaneously.

By executing processing steps 1210, 1212, and 1214, the processing device obtains one or more sentences from the respective article, where each sentence is associated with spatio-temporal coordinates, and disregards sentences that do not describe events associated with spatio-temporal coordinates.

It will be appreciated that the processing steps 1208-1214 are repeated for each historical character in the list of historical characters.

In one or more other embodiments, the processing device proceeds to processing step 1216.

At processing step 1216, the processing device links the set of events, the spatial information and the temporal information to obtain, for each historical character, space-time events 474 and character background text 476. In one or more embodiments, the processing device stores, in the knowledge database 270, for each historical character, one or more events associated with spatial information and location information. The space-time events 474 and character background text 476 of each historical character will be used to implement a respective conversational agent.

At processing step 1218, the processing device uses the conversational agent to generate, based on at least one the space-time events 474 and the character background text 476, a message. In one or more embodiments, the processing devices executes method 1400 to generate the message.

In one or more embodiments, the message may comprise one of an informative message and an interrogative message related to the extracted event associated with spatio-temporal coordinates.

The message may be stored and/or directly posted on the STS engine 222.

In one or more embodiments, the processing device generates a title for the message content, which will be used as the title of the post on STS engine 222.

The method 1200 then ends.

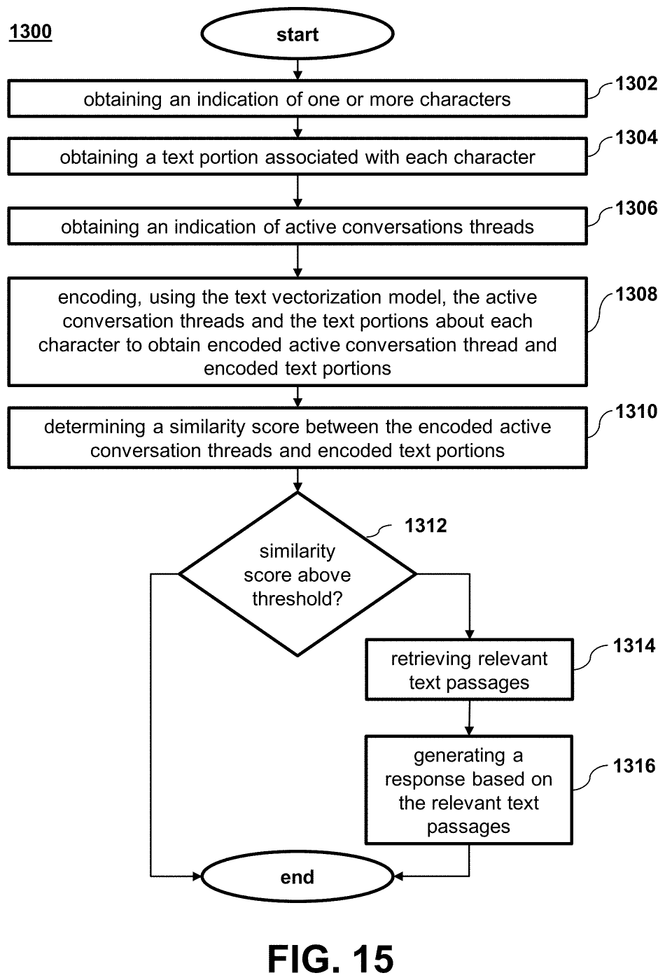

FIG. 15 depicts a flowchart of a method 1300 for selecting posts of interests on the space-time service (STS) platform 225 in accordance with one or more non-limiting embodiments of the present technology.

In one or more embodiments, the training server 230 comprises a processing device such as the processor 110 and/or the GPU 111 operatively connected to a non-transitory computer-readable storage medium such as the solid-state drive 120 and/or the random-access memory 130 storing computer-readable instructions. The processing device, upon executing the computer-readable instructions, is configured to or operable to execute the method 1300.

The method 1300 begins at processing step 1302.

At processing step 1302, the processing device obtains an indication of one or more characters. In one or more embodiments, the indication of the one or more historical characters may be in the form of a list of historical characters obtained from the knowledge database 270. The list of historical characters may include historical characters associated with one or more events, with each event being associated with spatio-temporal coordinates. The one or more events for each historical character may have been extracted by executing the method 1200.

In one or more embodiments, the indication of the historical characters may be obtained based on spatial coordinates (i.e., locations within a threshold range) and/or temporal coordinates (i.e., dates within a threshold range).

At processing step 1304, the processing device obtains a text portion representing the background knowledge associated with each character. In one or more embodiments, the text portion associated with each character comprises the character background text having been generated by executing method 1200. In one or more embodiments, the text portion comprises a summary text about each historical character. Summary text may have been generated based on the respective article about the historical character in the knowledge database 270.

At processing step 1306, the processing device obtains an indication of active conversation threads 620 on the STS engine 222.

In one or more embodiments active conversation threads 620 may for example include conversation threads having been posted on the STS engine 222 within a predetermined period of time, a specific location, and/or having a predetermined number of replies, or having been posted by users having been active on the STS engine 222 within a predetermined period of time. In one or more alternative embodiments, the active conversation threads 620 may be accessed based on a predefined search domain related to each of the characters background. In this case, the agents browse specific locations and timeframes on the STS engine 222, having a relationship with their biographical information (e.g., their birthplace). The active conversation threads 620 may include messages posted in text format, locations and timestamps associated with the messages. In one or more alternative embodiments, the active conversation threads may include all conversation threads in the STS engine 222, if it corresponds to the first-time involvement of the agents in the STS platform 225.

At processing step 1308, the processing device encodes, by using the text vectorization model 258, the active conversation threads 620 and the text portions about each character to obtain encoded active conversation thread 640 and encoded text portion 630. The encoded text portion 630 and the encoded active conversation thread 640 are represented in the form of embeddings or vectors in a multidimensional space. This representation enables comparing the text portion associated with the historical character and text included in the active conversation threads 620.

At processing step 1310, the processing device determines a similarity score between the encoded active conversation thread 640 and encoded text portion 630. The processing device obtains, for each of the active conversation thread 640 and each of the encoded text portion 630, a similarity score indicative of a similarity between the text portion and messages in the active conversation thread.

In one or more embodiments, the similarity score is determined by calculating a distance between the encoded summary text and the conversation thread in the multidimensional space. As a non-limiting example, the similarity score may be determined by calculating a cosine similarity.

At processing step 1312, the processing device determines if the similarity scores are above a threshold.

In one or more embodiments, the threshold may be predetermined. It will be appreciated that the similarity scores being above the threshold may indicate that historical events in the life of a given historical character may be relevant to messages in a given active conversation thread such that the dialogue generation model 252 may be used to take the identity of the given historical character and generate a message in the relevant conversation thread on the STS engine 222.

If the similarity score is equal to or above the threshold, the processing device proceeds to processing step 1314. If the similarity score is below the threshold, the method 1300 ends. It will be appreciated that at processing step 1312, each similarity score between conversation threads and text portions may be compared with the threshold.

At processing step 1314, the processing device retrieves relevant text passages related to the given historical character which is associated with the encoded conversation context having a similarity score equal to or above the threshold.

In one or more embodiments, the processing device obtains the relevant text passage from the knowledge database 270. The relevant text passage may include character background data having been extracted for each event associated with spatio-temporal coordinates in the life of the given historical character.

At processing step 1316, the processing device generates, based on the relevant text passage, a message in the active conversation thread.

In one or more embodiments, the message may be in the form of a factual statement and may be provided as response to a question from a user.

In one or more embodiments, the processing device executes method 1400 to generate the message.

The method 1300 then ends.

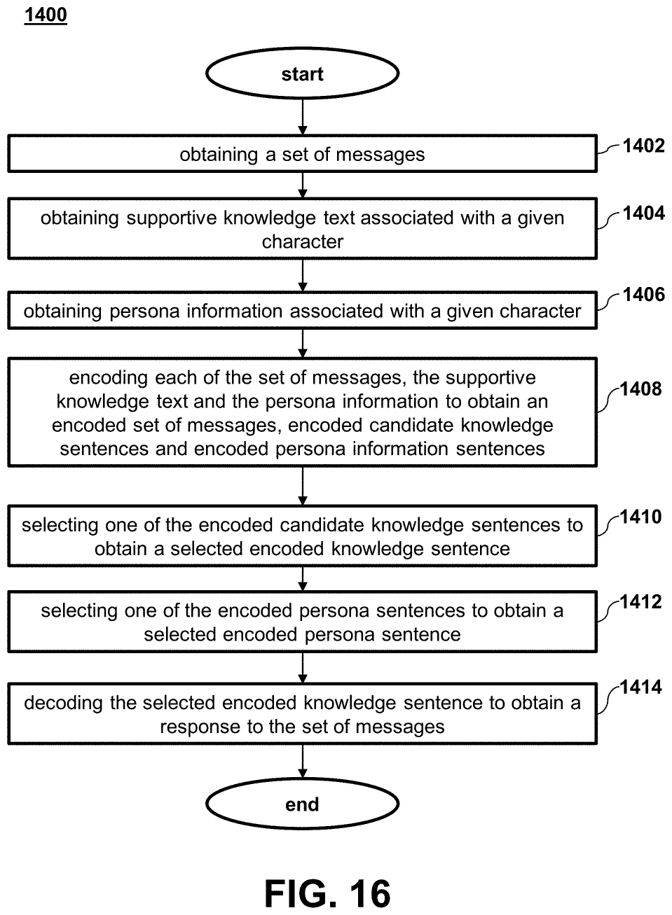

FIG. 16 depicts a flowchart of a method 1400 for generating a message on the STS engine 222 by using a dialogue generation model 252 in accordance with one or more non-limiting embodiments of the present technology.

In one or more embodiments, the training server 230 comprises a processing device such as the processor 110 and/or the GPU 111 operatively connected to a non-transitory computer readable storage medium such as the solid-state drive 120 and/or the random-access memory 130 storing computer-readable instructions. The processing device upon executing the computer-readable instructions, is configured to or operable to execute the method 1400.

The training server 230 has access to the dialogue generation model 252. The training server 230 is connected to the STS engine 222.

The method 1400 begins at processing step 1402.

At processing step 1402, the processing device obtains a set of messages 1110. In one or more embodiments, the set of messages are in the form of a dialogue in a conversation thread on the STS engine 222. The dialogue is associated with space-time coordinates on the STS engine 222 and a given topic.

At processing step 1404, the processing device obtains supportive knowledge text 1120 associated with a given historical character. The given historical character may have been previously selected during the method 1300 based on the similarity score between the text portion associated with the given historical character and the dialogue in the STS engine 222.

In one or more embodiments, the supportive knowledge text 1120 may be obtained by executing the method 1200.

At processing step 1406, the processing device obtains persona information text 1130 associated with the given historical character.

In one or more embodiments, the persona information text comprises text sentences indicative of personality traits and writing style of the given historical character.

At processing step 1408, the processing device uses the encoder 520 of the dialogue generation model 252 to encode each of the set of messages 1110, the supportive knowledge text 1120 and the persona information text 1130 to obtain an encoded set of messages 1140, encoded candidate knowledge sentences 1150 and encoded persona information sentences 1160.

At processing step 1410, the processing device uses the knowledge attention mechanism 530 of the dialogue generation model 252 to process the encoded candidate knowledge sentences 1150 to obtain a selected encoded knowledge sentence 1152. The selected encoded knowledge sentence 1152 is indicative of a knowledge sentence being relevant to the topic of the dialogue in the STS engine 222.

At processing step 1412, the processing device uses the persona attention mechanism 535 of the dialogue generation model 252 to process the encoded candidate persona information sentences 1160 to obtain a selected encoded persona information sentence 1162.

At processing step 1414, the processing device uses the decoder 540 of the dialogue generation model 252 to decode the selected encoded knowledge sentence 1152 and the selected encoded persona information sentence 1162 to obtain a dialogue response 1170. The decoder 540 transform the multidimensional space representation of the selected encoded knowledge sentence 1152 and the selected encoded persona information sentence 1162 into a natural language utterance. The dialogue response 1170 is in the form of one or more sentences which may have been written or pronounced by the given historical character and which are relevant to the conversation on the STS engine 222.

The method 1400 ends.

It should be expressly understood that not all technical effects mentioned herein need to be enjoyed in each and every embodiment of the present technology. For example, embodiments of the present technology may be implemented without the user enjoying some of these technical effects, while other non-limiting embodiments may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fiber-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting.

What is claimed is:

1. A method for providing a relevant natural language response to a conversation thread by a trained conversational agent model, the method being executed by a processor, the method comprising:
obtaining a conversation thread comprising at least one message, the conversation thread being associated with space-time coordinates;
obtaining, based at least on the space-time coordinates, a character identity for the trained conversational agent model;
obtaining, based on the character identity, a supportive knowledge text associated with the character;
encoding the conversation thread and the supportive knowledge text to obtain an encoded conversation thread and encoded knowledge text portions;
selecting, based on the encoded conversation thread, an encoded knowledge text portion; and
generating, by the trained conversational agent model, based at least on the encoded knowledge text portion, a relevant natural language response to the conversation thread.

2. The method of claim 1, wherein the conversational agent model is based a transformer language model (TLM).

3. The method of claim 2, wherein the response is related to an event in a life of the character, the event being associated with at least a portion of the space-time coordinates.

4. The method of claim 3, wherein the response comprises one of: an informative text message and an interrogative text message.

5. The method of claim 4, wherein said generating of, by the trained conversational agent model, based at least on the encoded knowledge text portion, the relevant natural language response to the conversation thread is further based on encoded persona information, the encoded persona information having been generated by encoding persona sentences indicative of at least one of: persona facts about the character and a writing style of the character.

6. The method of claim 5, further comprising, during a training procedure of the conversational agent model:
obtaining a past conversation thread associated with space-time coordinates, the past conversation thread comprising a plurality of messages;
obtaining a supportive knowledge text associated with a character;
generating, based on the past conversation thread, a search query;
embedding each of the search query and the supportive knowledge text to obtain a search query vector and supportive knowledge text vectors;
determining a respective distance between the search query vector and each supportive knowledge text vector;
selecting, based on the respective distances, a first set of knowledge sentences from the supportive knowledge text;
extracting a set of keywords from the conversation thread;
matching the set of keywords with a set of knowledge sentences from the supportive knowledge text;
selecting, based on said matching, a second set of knowledge sentences from the supportive knowledge text; and
training the conversational agent model to generate a response to a given conversation thread based on: the first set of knowledge sentences and the second set of knowledge sentences.

7. The method of claim 6, wherein said training of the conversational agent model to generate the response to the given conversation thread based on the first set of knowledge sentences and the second set of knowledge sentences is further based on a candidate answer, the candidate answer having been generated by:
determining, based on the search query, a question; and
predicting, using a knowledge-based question-answering model, a candidate answer to the question, said predicting being based on the supportive knowledge text.

8. The method of claim 7, wherein the character comprises a historical character.

9. The method of claim 8, wherein the conversation thread is associated with a point of interest (POI) associated with the space-time coordinates, and wherein the selected encoded knowledge text portion is related to the POI.

10. The method of claim 9, further comprising, prior to said obtaining of the supportive knowledge text associated with the character:
obtaining, from a knowledge source database, at least one text document associated with the character;
parsing the at least one text document to obtain a respective parsed tree for each sentence;
extracting a set of events from the at least one text document, each event being associated with space-time coordinates, said extracting comprising, for each respective parsed document:
extracting, using a first name entity recognition model, respective temporal information;
extracting, using a second name entity recognition model, respective location information; and
extracting a respective event of the set of events, the respective event being associated with the respective temporal information and the respective location information; and
storing the set of events as a supportive events knowledge text in association with the supportive knowledge text.

11. A system for providing a relevant natural language response to a conversation thread by a trained conversational agent model, the system comprising:
a non-transitory storage medium storing computer-readable instructions; and
a processor operatively connected to the non-transitory storage medium, the processor, upon executing the computer-readable instructions, being configured for:
obtaining a conversation thread comprising at least one message, the conversation thread being associated with space-time coordinates;
obtaining, based at least on the space-time coordinates, a character identity for the trained conversational agent model;
obtaining, based on the character identity, a supportive knowledge text associated with the character;
encoding the conversation thread and the supportive knowledge text to obtain an encoded conversation thread and encoded knowledge text portions;
selecting, based on the encoded conversation thread, an encoded knowledge text portion; and
generating, by the trained conversational agent model, based at least on the encoded knowledge text portion, a relevant natural language response to the conversation thread.

12. The system of claim 11, wherein the conversational agent model is based a transformer language model (TLM).

13. The system of claim 12, wherein the response is related to an event in a life of the character, the event being associated with at least a portion of the space-time coordinates.

14. The system of claim 13, wherein the response comprises one of: an informative text message and an interrogative text message.

15. The system of claim 14, wherein said generating of, by the trained conversational agent model, based at least on the encoded knowledge text portion, the relevant natural language response to the conversation thread is further based on encoded persona information, the encoded persona information having been generated by encoding persona sentences indicative of at least one of: persona facts about the character and a writing style of the character.

16. The system of claim 15, wherein said processor is further configured for, during a training procedure of the conversational agent model:
obtaining a past conversation thread associated with space-time coordinates, the past conversation thread comprising a plurality of messages;
obtaining a supportive knowledge text associated with a character;
generating, based on the past conversation thread, a search query;
embedding each of the search query and the supportive knowledge text to obtain a search query vector and supportive knowledge text vectors;
determining a respective distance between the search query vector and each supportive knowledge text vector;
selecting, based on the respective distances, a first set of knowledge sentences from the supportive knowledge text;
extracting a set of keywords from the conversation thread;
matching the set of keywords with a set of knowledge sentences from the supportive knowledge text;
selecting, based on said matching, a second set of knowledge sentences from the supportive knowledge text; and
training the conversational agent model to generate a response to a given conversation thread based on: the first set of knowledge sentences and the second set of knowledge sentences.

17. The system of claim 16, wherein said training of the conversational agent model to generate the response to the given conversation thread based on the first set of knowledge sentences and the second set of knowledge sentences is further based on a candidate answer, the candidate answer having been generated by:
determining, based on the search query, a question; and
predicting, using a knowledge-based question-answering model, a candidate answer to the question, said predicting being based on the supportive knowledge text.

18. The system of claim 17, wherein the character comprises a historical character.

19. The system of claim 18, wherein the conversation thread is associated with a point of interest (POI) associated with the space-time coordinates, and wherein the selected encoded knowledge text portion is related to the POI.

20. The system of claim 19, wherein said processor is further configured for, prior to said obtaining of the supportive knowledge text associated with the character:
obtaining, from a knowledge source database, at least one text document associated with the character;
parsing the at least one text document to obtain a respective parsed tree for each sentence;
extracting a set of events from the at least one text document, each event being associated with space-time coordinates, said extracting comprising, for each respective parsed document:
extracting, using a first name entity recognition model, respective temporal information;
extracting, using a second name entity recognition model, respective location information; and
extracting a respective event of the set of events, the respective event being associated with the respective temporal information and the respective location information; and
storing the set of events as a supportive events knowledge text in association with the supportive knowledge text.
